(19) United States
(12) Patent Application Publication
(10) Pub. No.: US 2023/0064124 A1
(43) Pub. Date: Mar. 2, 2023

(54) User-Assisted Autonomous Vehicle Motion Initiation for Transportation Services

(71) Applicant: Uber Technologies, Inc., San Francisco, CA (US)

(72) Inventors: Zelin Liu, Seattle, WA (US); Ashwin Neurgaonkar, San Francisco, CA (US); Zhuofu Li, San Bruno, CA (US); Atibhav Mittal, San Francisco, CA (US); Nihal Reddy Pathuri, San Francisco, CA (US)

(21) Appl. No.: 17/466,444

(22) Filed: Sep. 3, 2021

Related U.S. Application Data
(60) Provisional application No. 63/237,356, filed on Aug. 26, 2021.

(51) Int. Cl. B60W 60/00; B60W 40/13; B60W 50/14

(52) U.S. Cl. CPC B60W 60/00253; B60W 40/13; B60W 50/14; B60W 60/00256; B60W 2540/215; B60W 2050/146

(57) ABSTRACT

Systems and methods of the present disclosure are directed to a verifying vehicle service readiness and controlling a vehicle. An example method can include communicating a service request and receiving a vehicle state payload including data descriptive of service condition item(s). The service condition item(s) can be descriptive of action(s) for placing an autonomous vehicle into appropriate condition for the vehicle service. The method can include providing, for display, the service condition item(s) to a user via a checklist element on an application. The method can include enabling a user ready element on the application based on a status of the service condition item(s) indicating that the autonomous vehicle is in appropriate condition for the vehicle service. The method can include receiving data indicative of an interaction by the user with the user ready element and, in response, communicating a request for a vehicle verification to the backend.

### RELATED APPLICATION

The present application is based on and claims benefit of U.S. Provisional Patent Application No. 63/237,356 having a filing date of Aug. 26, 2021, which is incorporated by reference herein.

### FIELD

The present disclosure relates generally to improvements in the operation of autonomous vehicles, and more particularly, to improvements in verifying autonomous vehicle service readiness and initiating motion of an autonomous vehicle to travel for a vehicle service.

### BACKGROUND

As autonomous vehicle driving technology improves, autonomous vehicles have become increasingly useful in a number of technology fields. One potential use of autonomous vehicles is to provide on-demand transportation services to passengers and organizations that have the need for transportation services. Such services can include a passenger transportation service, a courier service, and a delivery service. Managing such an on-demand transportation service can include providing a variety of services to passengers and autonomous vehicles.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method. The method includes communicating, by a computing system including one or more computing devices, a request for a vehicle service to a backend via an application. The method includes receiving, by the computing system, a vehicle state payload from the backend. The vehicle state payload includes data descriptive of one or more service condition items, the one or more service condition items being descriptive of one or more actions for placing an autonomous vehicle into appropriate condition for the vehicle service. The method includes providing, by the computing system for display via a user interface, the one or more service condition items to a user via a checklist element on the application. The method includes enabling, by the computing system, a user ready element on the application based at least in part on a status of the one or more service condition items indicating that the autonomous vehicle is in appropriate condition for the vehicle service. The method includes receiving, by the computing system, data indicative of an interaction by the user with the user ready element. The method includes in response to receiving the data indicative of the interaction, communicating, by the computing system, a request for a vehicle verification to the backend.

Another example aspect of the present disclosure is directed to a computer-implemented method. The method includes receiving, by a computing system including one or more computing devices, a request for a vehicle service by an autonomous vehicle. The request for the vehicle service provided via an application on a user device. The method includes determining, by the computing system, a change in a vehicle state of the autonomous vehicle. The method includes determining, by the computing system, a vehicle state payload in response to the change in the vehicle state. The vehicle state payload includes data descriptive of one or more service condition items. The method includes providing, by the computing system, the vehicle state payload for display to a user via the application on the user device.

Another example aspect of the present disclosure is directed to a computing system. The computing system includes one or more processors and one or more non-transitory computer-readable media that store instructions that, when executed by the one or more processors, cause the computing system to perform operations. The operations include receiving a request for a vehicle service by an autonomous vehicle. The operations include determining a change in a vehicle state of the autonomous vehicle. The operations include determining a vehicle state payload in response to the change in the vehicle state. The vehicle state payload includes data descriptive of one or more service condition items. The operations include providing the vehicle state payload for display to a user of the autonomous vehicle via a user interface of a user device, wherein one or more service condition items are to be addressed by the user prior to allowing for initiation of the vehicle service by the autonomous vehicle.

Other example aspects of the present disclosure are directed to other systems, methods, vehicles, apparatuses, tangible non-transitory computer-readable media, and the like for initiating motion for an autonomous vehicle performing a vehicle service.

The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example vehicle system according to example embodiments of the present disclosure.

FIG. 2 depicts a block diagram of an example service infrastructure of an example platform according to example embodiments of the present disclosure.

FIG. 3 depicts a state diagram of an example service flow for an application according to example embodiments of the present disclosure.

FIGS. 4A-6B depict example user interfaces according to example embodiments of the present disclosure.

FIG. 7 depicts a block diagram of an example vehicle state payload flow according to example embodiments of the present disclosure.

FIG. 8 depicts a timing diagram of an example service flow according to example embodiments of the present disclosure.

FIG. 9 depicts a flowchart diagram of an example method for initiating a service and vehicle motion according to example embodiments of the present disclosure.

FIG. 10 depicts a flowchart diagram of another example method for initiating a service and vehicle motion according to example embodiments of the present disclosure.

FIG. 11 depicts a block diagram of an example computing system according to example embodiments of the present disclosure.

FIG. 12 depicts a block diagram of an example computing ecosystem according to example embodiments of the present disclosure.

### DETAILED DESCRIPTION

Generally, the present disclosure is directed to systems and methods for improved vehicle readiness state determination having improved user experience and/or user safety in an automatic ride-sharing vehicle. Prior to a vehicle transportation service (e.g., a user ride-sharing/hailing service, delivery service, courier service, etc.), it can be beneficial to verify conditions of the vehicle (e.g., autonomous vehicle) to ensure the vehicle's operational readiness and/or passenger safety. Some conditions within the vehicle can require action on the part of the passengers to place the vehicle into an acceptable condition for a service. For example, a passenger may be required to be seated and/or fasten a seatbelt, close and/or secure doors, trunk(s), or other compartments of the vehicle, or otherwise conform the vehicle and/or the passenger(s) to an acceptable state for travel.

A transportation service may be requested by a passenger from a user device belonging to the passenger, such as a mobile phone, smartphone, etc. For instance, the passenger may interact with an application (e.g., a ride-sharing/hailing/coordination application, etc.) on the passenger device to request a vehicle to be directed for pickup at or near the passenger's location. When the passenger enters the vehicle, the passenger can be shown a confirm service user interface on the user device (e.g., via the ride-sharing application, etc.). The confirm service user interface can display to the passenger basic information about the upcoming service, such as the passenger's name, approximate service route, etc. Additionally, the confirm service interface can provide a confirm service element (e.g., a soft button element, swipe element, etc.) to the passenger. The passenger can interact with the confirm service element after entering the vehicle to confirm that the passenger is committing to the service (e.g., riding in the vehicle to the destination, etc.).

Prior to initiating the service, a list of requirements to ensure safety and/or readiness of the vehicle can be satisfied. In the case of a human-driven vehicle, an on-vehicle operator can conduct a pre-service vehicle verification (e.g., a “cabin-check” including a review of a vehicle interior, etc.) to verify that the requirements are satisfied. For example, the on-vehicle operator can verify that passenger's seatbelt is fastened, doors of the vehicle are closed, etc. However, when the vehicle is an autonomous vehicle, the vehicle can lack an on-vehicle operator. Thus, to verify that the vehicle is in appropriate condition for a service, a remote operator can remotely perform a vehicle verification to confirm that the vehicle and/or passenger(s) are suitable for the service. For instance, the remote operator can remotely approve the vehicle for the service, or reject the vehicle, in which case the passenger(s) (and/or another party) will need to correct whatever conditions resulted in the rejection. The passenger(s) can then recommit to restart the service.

Without the presence of an on-vehicle operator to guide the passenger(s), it can be difficult for the passenger(s) to identify and/or correct the conditions that must be satisfied for the vehicle to be approved for a service. This can be complicated in the case of insufficient information being available to the passenger in an application used to request the service. For instance, upon interacting with the confirm service element, the passenger may be presented with a waiting user interface instructing the passenger to wait until the service is initiated (e.g., until the remote operator approves the vehicle for the service, etc.). With the advent of autonomous vehicles and the associated lack of an on-vehicle operator, it is desirable to provide increased details to the passenger via the application such that the passenger can have improved understanding and reduced confusion in placing the vehicle in proper condition for a service. Furthermore, it can be desirable to provide actionable feedback when service requirements are not met, in lieu of and/or supplementary to in-person assistance. In addition, in some cases, a remote operation may mistakenly approve a vehicle that is not in proper condition. Furthermore, it can be difficult to validate accuracy of the vehicle verification performed by the remote operator.

Example aspects of the present disclosure can provide for improved passenger comfort in a service vehicle, especially an autonomous vehicle as well as vehicle preparedness. For instance, example aspects of the present disclosure can provide for increased passenger confidence in acceptability of a condition of the vehicle. In addition, example aspects of the present disclosure can provide one or more passenger(s) with guidance for beginning a service (e.g., a user transportation service, delivery service, etc.). For instance, an application can provide the passenger(s) with improved clarity and/or directive regarding placing a vehicle and/or the passenger(s) into acceptable condition for a service. In addition, example aspects of the present disclosure can provide for improved availability of information for a remote operator, which can provide for decreased likelihood of falsely approved vehicle verifications.

According to example aspects of the present disclosure, once a passenger confirms his or her availability for a service (e.g., by the confirm service interface, etc.), the passenger can be presented with a service condition checklist user interface. The service condition checklist interface can display one or more service condition items and/or a status of the one or more service condition items to the passenger. In some implementations, the service condition items can include conditions that must be satisfied for the vehicle and/or the passenger(s) to be placed into appropriate condition for a service.

In some implementations, the service condition checklist user interface can include an action header element. The action header element can inform the passenger of any action that is urgent, immediate, critical, and/or otherwise of interest to be taken by the passenger. As one example, the action header element can display directive text such as “Get Ready!” and/or other text instructing the passenger to perform some action, such as text instructing the passenger to interact with a user interface element to indicate readiness, text instructing the passenger to fasten his or her seatbelt, text instructing the passenger to close and/or secure vehicle doors, text instructing the passenger to close and/or secure a vehicle trunk, and/or other suitable directive text. Additionally and/or alternatively, the action header element can inform the passenger if no further action is currently required on the part of the passenger. As one example, the action header element can display text such as “Hold on!” or “Hang tight!” and/or text informing the passenger that the status of the vehicle is pending confirmation.

Additionally and/or alternatively, the service condition checklist user interface can include a hardware state checklist element. The hardware state checklist element can display a checklist of action items to the passenger in a concise, graphical form. As an example, the hardware state checklist element can include, for at least some of the service condition items, an icon (e.g., graphic, etc.) representing the service condition item, a concise (e.g., in fewer than five words) description of the service condition item, and/or a concise and/or other graphical depiction of the status of the service condition item (e.g., a check icon representing that the item is satisfied). In some implementations, for example, the hardware state checklist item can provide information only for some of the service condition items, such as a doors closed condition, a trunk closed condition, and/or a seatbelts fastened condition.

Additionally and/or alternatively, the service condition checklist user interface can include a rules list element. The rules list element can display a list of rules to the passenger. The rules list element can be wordier than the hardware state checklist element (e.g., on the order of ten to twenty words per rule). As an example, the rules list element can include, for at least some of the rules, an icon representing the rule, a title of the rule, and/or a short description of the rule. As one example, the rules can include restrictions on items such as alcohol, firearms, hazardous materials, drugs, tobacco products, or other items. As another example, the rules can include restrictions on the placement of children within the vehicle, such as limiting children to the back seat. As another example, the rules can include a requirement that seatbelts remain fastened while the vehicle is in motion, until the service is completed, etc. The rules may or may not be verified by service condition item(s) directly. In some implementations, one or more of the rules can be verified by a remote operator when the passenger(s) have indicated readiness for the service.

Additionally and/or alternatively, the service condition checklist user interface can include a passenger ready element. The passenger can interact with the passenger ready element to indicate that the passenger is ready for the service. As an example, the passenger ready element can include a button, toggle, or other interactable element. The passenger ready element can display functional text, such as “I'm ready” or “Start service” or other suitable text indicating function of the passenger ready element. The passenger can be restricted from interacting with the passenger ready element until the service condition items are satisfied. For instance, the passenger can be restricted from interacting with the passenger ready element by “graying out” or hiding the passenger ready element until the service condition items are met.

The action header element, hardware state checklist element, rules list element, and/or other elements of the service condition checklist user interface can be populated on an application (e.g., a user interface thereof, etc.) of a client device based on data from a server computing system. For instance, the elements of the service condition checklist user interface can be populated with data from a vehicle state payload delivered (e.g., periodically, scheduled, etc.) from the server computing system to the client device. Additionally and/or alternatively, a similarly and/or identically structured vehicle state payload can be delivered from the client device to the server computing system. For instance, in one example implementation, the vehicle state payload can be and/or can include at least one service blocking item data structure. The service blocking item data structure can represent a condition item that blocks (e.g., prevents, prohibits, limits, etc.) the vehicle from performing a service. The service blocking item data structure can include one or more values. As one example, the service blocking item data structure can include a name. The name can be, for example, a string. Additionally and/or alternatively, the service blocking item data structure can include an icon reference. The icon reference can be, for example, a URL. The icon reference can provide a reference to an icon representing the service blocking item. Additionally and/or alternatively, the service blocking item data structure can include a status. The status can represent a status of the service block item. As one example, in some implementations, values of the status can be selected from one of an invalid status, a to-be-addressed status, an addressed status, and/or a warning status. Service blocking items having a warning status can have a warning severity. The warning severity can be indicative that the action is provided only as a warning and will not block the service if unaddressed.

In some implementations, the vehicle state payload can include a list of service blocking items. Additionally and/or alternatively, the vehicle state payload can be transmitted in response to unblocking a specific item in the list of service blocking items. For instance, the vehicle state payload can include a task identifier. The task identifier can identify a task that is specific to the vehicle state payload. For example, the task identifier can be a numeric value, such as an integer, a string, and/or any other suitable value(s). Additionally and/or alternatively, the vehicle state payload can include an action title. The action title can be a title of a primary action to unblock. For example, the action title can be a numeric value, such as an integer, a string, and/or any other suitable value(s). Additionally and/or alternatively, the vehicle state payload can include an action description. The action description can be a description of a primary action to unblock. As an example, the action description can be a string.

For instance, a backend (e.g., a backend service of a server computing system that is remote from the user device, etc.) can dynamically generate a vehicle state payload of service blocking items. The vehicle state payload can represent items that would block a vehicle (e.g., a self-driving vehicle, etc.) from operating normally and/or safely on a service. The vehicle state payload can be pushed from a gateway service at the backend. A client service (e.g., a RaMEN client, etc.) can receive the vehicle state payload from the backend.

The vehicle state payload can be triggered by one or more events within a service. As one example, the vehicle state payload can be triggered when a passenger has been identified from an application, such as when the passenger requests to start a service (e.g., a transportation service, etc.). For instance, in some implementations, an itinerary report listener (e.g., a Kafka topic or similar listener service, etc.) can listen to an itinerary service on the backend. The itinerary service can advance a service status to a pickup status for a vehicle when a passenger requests a service and has been assigned the vehicle. When the itinerary report listener detects that the service state has advanced to the pickup task, the itinerary report listener can trigger a call to push the vehicle state payload to the application. As another example, in some implementations, the vehicle state payload can be triggered throughout the service itself. For instance, a service state listener (e.g., a Kafka topic or similar listener service, etc.) can listen to the itinerary service for state changes on the service state. When the service state listener detects that the service state has changed during a service, the service state listener can trigger a call to push the vehicle state payload to the application. For example, the service state listener can listen for changes to door state, trunk state, seatbelt state, or other states related to service blocking items. As another example, a vehicle verification listener (e.g., a Kafka topic or similar listener service, etc.) can listen for completion of a vehicle verification (e.g., through a vehicle interior/exterior check service, etc.). When the vehicle verification listener detects a completed vehicle verification (e.g., a cabin check, etc.), the vehicle verification listener can call to push the vehicle state payload to the application.

In some implementations, a single listener (e.g., a single Kafka topic, etc.) can listen for all states. In some implementations, a separate listener (e.g., a unique Kafka topic, etc.) can listen for a particular state. Including multiple listeners for each state can, in some cases, improve scalability and/or reduce bandwidth. For example, multiple listeners can improve scalability as, for each potential new state required for the vehicle, it can be possible to add a new listener for that state. This can be easier than designing a backwards-compatible change on the single listener. As another example, multiple listeners can reduce bandwidth such as by providing that, for a state change, only data relevant to that particular state change can be sent over a network, rather than requiring a single listener to provide information about all states on each state change.

In some implementations, the backend can be implemented at least partially using a push architecture wherein, when a client requests work by a call (e.g., an RPC call, etc.) from a server, the work can be pushed to the server as a request. The result of the request can be sent back to the client as a response. The push architecture can be beneficial, as the vehicle state changes can be addressed as soon as they are changed. As another example, in some implementations, the backend can be implemented at least partially using a pull architecture, where the server can request work through an intermediate queue service. The queue service can forward the request from the server to the appropriate client.

For instance, example aspects of the present disclosure can provide for the following experience for a passenger in requesting a service. A passenger can operate a user device. The user device can be any suitable computing device. For example, the user device can be or can include a laptop computer, desktop computer, mobile phone, smartphone, tablet computer, wearable device, and/or other suitable computing device. The passenger can open an application on the user device. The application can provide for the passenger to request a service by a vehicle (e.g., autonomous vehicle, etc.). Once the passenger requests a service, the vehicle can be deployed to the passenger's location to pick up the passenger. Additionally, a service state associated with the application on the backend can be updated (e.g., by the itinerary service, etc.) to a pickup status. The service state update can trigger the itinerary report listener to call for the passengers of the service to be verified.

Once the vehicle has arrived at the passenger's location, the passenger can enter the vehicle. Upon entering the vehicle, the passenger can be presented with the confirm service user interface via the application. The passenger can confirm that the information on the confirm service user interface is accurate. Additionally, the passenger can interact with the confirm service element to confirm the service.

The passenger can then be presented with the service condition checklist user interface. Actions requiring the passenger's attention can be presented by the action header element. Additionally, the full list of requirements to begin the vehicle service can be displayed in the hardware state checklist element interface and/or the rules list. As the passenger makes changes to the state of the vehicle that produce meaningful vehicle state changes, an updated vehicle state payload can be pushed to the application such that the changes are reflected in the hardware state checklist, action header, etc. If, at a point in time, the passenger has conformed to the list of requirements (e.g., all doors are closed, at least one seatbelt is fastened, etc.) through interaction with the user interface, then the passenger can be presented with the passenger ready element. Additionally and/or alternatively, the passenger ready element can be highlighted, made more visible in style, flashed between two or more colors, intensities, etc., or otherwise increased in visual awareness to the passenger in response to the list of requirements being satisfied.

Upon the passenger interacting with the passenger ready element, the passenger can be presented with a waiting user interface that notifies the passenger to wait. As one example, the action header element can be modified in the waiting user interface to instruct the passenger to wait. During this time, a remote operator can perform a vehicle verification, including, for example, remotely inspecting the state of the autonomous vehicle through one or more cameras, sensors, or other remote devices. The passenger(s) may be made aware of the inspection of the remote operator, in some implementations. The remote operator can approve the vehicle for the vehicle service and/or reject the vehicle for the vehicle service. If the remote operator approves the vehicle, a service state can progress and the passenger can be provided with an on-service interface detailing progress of the vehicle service (e.g., the progress of transporting the passenger to a destination, etc.). Additionally and/or alternatively, if the remote operator rejects the vehicle, the passenger can be provided with one or more interface elements that explain to the passenger the reason for rejection. For instance, commentary can be provided to the passenger (e.g., via the hardware state checklist element, etc.) indicating further actions the passenger can take to place the vehicle into condition for the vehicle service.

In some implementations, once the vehicle verification has been successfully completed, the passenger can be enabled to begin the service. For instance, a successful completion of the vehicle verification can be reflected in a vehicle verification service. This can trigger a vehicle verification listener to call for a vehicle state payload to be pushed to the application. In some cases, this call can be agnostic to the trigger, so the entire vehicle state payload can be gathered and/or pushed. Additionally and/or alternatively, in some implementations, the backend can query the itinerary service to verify that the vehicle is still in the pickup state. Additionally and/or alternatively, in some implementations, the backend can query the vehicle verification service to verify that the vehicle verification was successful. Once these verifications have been completed, the vehicle verification service can return whether or not the vehicle is in a service blocking state. Additionally, the backend can provide the application with the appropriate interface to display. For instance, if the vehicle is not in a service blocking state, the backend can push a vehicle state payload with the passenger ready element enabled. If the vehicle is still in a service blocking state, the vehicle state payload can be pushed and the service blocking items can be displayed (e.g., via the hardware state checklist, etc.) to the passenger.

While the vehicle service is underway, the passenger(s) may cause changes to the state of the vehicle that could potentially return the vehicle to a service blocking state. To address this, a service state listener can listen to the service state to detect meaningful state changes that return the vehicle to a service blocking state. As one example, if the vehicle requires all doors of the vehicle to be closed to carry out the vehicle service, the service state listener may listen for state changes in door states of the vehicle to detect that a door has been opened. As another example, if the vehicle requires passenger(s) to have fastened seatbelts, the service state listener may listen for state changes in seatbelt states of the vehicle to detect that a seatbelt has been unfastened. The changes in service state can trigger the vehicle state payload to be delivered to the application to instruct the passenger(s) of actions that are needed to return the vehicle to an appropriate state to resume the service.

If the vehicle has been placed into a service blocking state during a service, the passenger can be presented with a resume service element once the vehicle has been returned to an appropriate condition for a vehicle service. The passenger can interact with the resume service element to cause the vehicle to resume the vehicle service.

Example aspects of the present disclosure can provide a number of technical effects and benefits. For example, systems and methods according to example aspects of the present disclosure can help ensure that a vehicle service is in a condition to start. For instance, the technology of the present disclosure can allow for a two-tiered vehicle check whereby the in-person user is directed through a guided user interface flow and a remote operator is able to verify thereafter (or vice versa). The guided user interface flow can be used to efficiently complete vehicle status review. The technology of the present disclosure can reduce the likelihood that the service will need to be stopped or changed prior to completion. As such, the described technology can save significant computing resources that may otherwise be used to support the stop and/or change request within the context of an autonomous vehicle. This can include saving onboard and offboard processing resources to diagnose and determine a remediation action for a condition, communication/bandwidth resources needed for mid-service remote assistance, etc. Moreover, by proactively engaging user(s) to assess the service readiness of an autonomous vehicle, the autonomous vehicle can allocate less processing and memory resources for in-vehicle sensor data processing, etc. needed to confirm readiness. This allows for longer vehicle deployment time and avoids unnecessary vehicle downtime at service depots (e.g., where a vehicle may need to download its memory bank). Additionally, the technology of the present disclosure provides for reduced confusion and/or improved sense of safety and trust for passenger(s) during a service, such as prior to initiating a service in an autonomous vehicle. Additionally and/or alternatively, systems and methods according to example aspects of the present disclosure can improve passenger preparedness and/or reduce the likelihood that a passenger will request a change mid-service. Accordingly, the technology of the present disclosure can improve vehicle service preparedness and reduce the level of computing resources that would be needed for the autonomous vehicle (and/or a remote computing system) to implement a change mid-service.

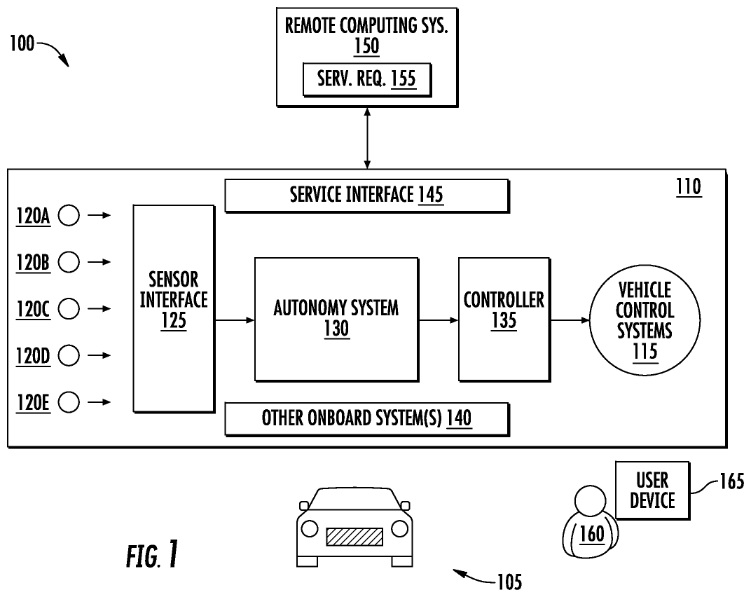

With reference now to the FIGS., example aspects of the present disclosure will be discussed in further detail. FIG. 1 depicts a block diagram of an example vehicle system 100 according to example embodiments of the present disclosure. The system 100 can include a vehicle 105 and a vehicle computing system 110 associated with the vehicle 105. The vehicle computing system 110 can be located onboard the vehicle 105 (e.g., it can be included on and/or within the vehicle 105).

The vehicle 105 incorporating the vehicle computing system 110 can be various types of vehicles. For instance, the vehicle 105 can be an autonomous vehicle. The vehicle 105 can be a ground-based vehicle (e.g., car, truck, bus, etc.), air-based vehicle (e.g., airplane, helicopter, etc.), a light-weight electric vehicle (e.g., bicycle, scooter, etc.), or another type of vehicle (e.g., watercraft, etc.). The vehicle 105 can drive, navigate, operate, etc. with minimal and/or no interaction from a human operator (e.g., driver, etc.). In some implementations, a human operator can be omitted from the vehicle 105 (and/or also omitted from remote control of the vehicle 105). In some implementations, a human operator can be included in the vehicle 105. The vehicle 105 can be configured to operate in a plurality of operating modes. The vehicle 105 can be configured to operate in a fully autonomous operating mode in which the vehicle 105 is controllable without user input, a semi-autonomous operating mode in which the vehicle 105 can operate with some input from a human operator present in (and/or remote from) the vehicle 105, a manual operating mode in which the vehicle 105 is fully controllable by a human operator, and/or other operating modes.

The vehicle computing system 110 can include various systems for operating the vehicle 105. For example, the vehicle computing system 110 can be a computer or processing system which operates to process sensor information on the vehicle 105 in order to interface and control the vehicle 105. Additionally, the vehicle computing system 110 can include other functionality, including wireless communication capabilities in order to send and/or receive wireless communications with one or more remote sources, such as a remote computing system 150 of FIG. 1. In controlling the vehicle 105, the vehicle computing system 110 can issue instructions and data which programmatically control various electromechanical components of the vehicle, in order to control aspects of vehicle motion such as propulsion, braking, steering, auxiliary behavior (e.g., turning lights on), etc. via one or more vehicle control systems 115.

According to some examples, vehicle 105 can include the vehicle computing system 110, as well as a collection of sensors 120A-E for enabling the vehicle 105 to perceive its surrounding environment. The sensors of the autonomous vehicle 105 can be utilized to help provide a computerized perception of the space and environment surrounding the vehicle 105. Likewise, the vehicle computing system 110 can operate within the vehicle 105 to receive sensor data from one or more of the sensors 120A-E, and to control various vehicle components for operating the vehicle 105 on roadways, etc.

The plurality of sensors 120A-E can operate to obtain a complete sensor view surrounding the vehicle 105, and further obtain information about what is near the vehicle 105, as well as what is near or in front of a path of travel for the vehicle 105. By way of example, the plurality of sensors 120A-E include one or more cameras 120A (video camera, stereoscopic pairs of cameras or depth perception cameras, long range cameras, etc.), remote detection sensors, such as provided by RADAR or LIDAR 120B, proximity or touch sensors 120C, audio sensors 120D, and/or other sensors 120E. The vehicle 105 can also include one or more interior sensors. This can include, for example, cameras with a field of view inside an interior of the vehicle 105. Moreover, one or more sensors can be associated with vehicle components (e.g., doors, seatbelts, trunk, windows, seats, etc.) to detect a state change of that vehicle component (e.g., closed/opened, locked/unlocked, up/down, fastened/not-fastened, within/outside designated area, etc.).

The sensor interface 125 receives raw sensor data from the various sensors 120A-E. The raw sensor data can represent output signal(s) or communication(s) from the variety of sensors 120A-E. The sensor interface 125 can process raw sensor data in order to generate a sensor profile set. The sensor profile set can be subjected to one or more processes of a sensor analysis component. The processes of sensor analysis component operate to generate sensor data, which can be processed as, for example, a parametric or instructional input for other components of the vehicle computing system 110.

In some implementations, the sensor data can be indicative of one or more objects within the surrounding environment of the vehicle 105. The object(s) can include, for example, vehicles, pedestrians, bicycles, and/or other objects. The object(s) can be located in front of, to the rear of, to the side of, above, below the vehicle 105, etc. The sensor data can be indicative of locations associated with the object(s) within the surrounding environment of the vehicle 105 at one or more times. The object(s) can be static objects (e.g., not in motion) and/or dynamic objects/actors (e.g., in motion or likely to be in motion) in the vehicle's environment. The sensor(s) 120A-E can provide the sensor data to the autonomy system 130 via the sensor interface 125.

The autonomy system 130 can perform functions for autonomously operating the vehicle 105. For example, the autonomy system 130 can obtain the sensor data via the sensor(s) 120A-E/sensor interface 125, process the sensor data (and/or other data) to perceive the vehicle's surrounding environment, predict the motion of objects within the surrounding environment, and/or generate an appropriate motion plan through such surrounding environment. The autonomy system 130 can include one or more rules, algorithms, machine-learned models, etc. to perform these functions. This can include objective function(s) to select a motion plan for the vehicle 105. The selected motion plan can include vehicle actions (e.g., speed(s), acceleration(s), other actions, etc.). The motion plan can include one or more vehicle motion trajectories that indicate a path for the vehicle 105 to follow. A vehicle motion trajectory can be of a certain length and/or time range. A vehicle motion trajectory can be defined by one or more way points (with associated coordinates) to which the vehicle is to travel.

The autonomy system 130 can communicate with the one or more vehicle control systems 115 to operate the vehicle 105 according to the motion plan (e.g., via the vehicle controller interface 135, etc.). The vehicle computing system 110 can cause the vehicle 105 to initiate a motion control in accordance with at least a portion of the motion plan. A motion control can be an operation, action, etc. that is associated with controlling the motion of the vehicle 105. For instance, the motion plan can be provided to the vehicle control system(s) 115 of the vehicle 105. The vehicle control system(s) 115 can be associated with a vehicle controller interface 135 that is configured to implement a motion plan. The vehicle interface 135 can serve as an interface/conduit/module between the autonomy system 130 and the vehicle control systems 115 of the vehicle 105 and any electrical/mechanical controllers associated therewith. The vehicle controller interface 135 can, for example, translate a motion plan into instructions for the appropriate vehicle control system 115 (e.g., acceleration control, brake control, steering control, etc.). The vehicle control systems 115 can include a propulsion system, a steering system, a braking system, and lighting/auxiliary system, and/or other control systems for vehicle operation. The vehicle controller interface 135 can provide vehicle control signals to control propulsion, steering, braking and other vehicle behavior while the vehicle 105 follows a route. Thus, while the vehicle 105 may follow a route, the autonomy system 130 can continuously adjust and alter the movement of the vehicle in response to receiving the sensor data. Absent events or conditions which affect the confidence of the vehicle in safely progressing on the route, the vehicle computing system 110 can process sensor data in order to generate various vehicle control signals for the different control systems 115, via the vehicle controller interface 135. This can allow the vehicle 105 to autonomously travel within the vehicle's surrounding environment.

The vehicle computing system 110 can include one or more other systems 140 that are located onboard the vehicle 105. For example, the vehicle computing system 110 can include a map data storage system. The autonomy system 130 can obtain the map data. The map data can provide detailed information about the surrounding environment of the vehicle 105. The vehicle 105 can include a positioning system The positioning system can determine a current position of the vehicle 105. This can help the vehicle 105 localize itself within its environment. The positioning system can be any device or circuitry for analyzing the position of the vehicle 105. For example, the positioning system can determine position by using one or more of inertial sensors (e.g., inertial measurement unit(s), etc.), a satellite positioning system, based on IP address, by using triangulation and/or proximity to network access points or other network components (e.g., cellular towers, WiFi access points, etc.) and/or other suitable techniques. The position of the vehicle 105 can be used by various systems of the vehicle computing system 110 and/or provided to a remote computing system. For example, the map data can provide the vehicle 105 relative positions of the elements of a surrounding environment of the vehicle 105. The vehicle 105 can identify its position within the surrounding environment (e.g., across six axes, etc.) based at least in part on the map data. For example, the vehicle computing system 110 can process the sensor data (e.g., LIDAR data, camera data, etc.) to match it to a map of the surrounding environment. Data indicative of the vehicle's position can be stored, communicated to, and/or otherwise obtained by the autonomy computing system 130.

The vehicle computing system 110 can include a service interface 145. For example, the vehicle 105 can utilize one or more remote backend services of a remote computing system 150, as further described herein. The remote computing system 150 can be, for example, an operations computing system of a service entity. A service entity can be an entity that coordinates, manages, arranges, supports, etc. vehicle services for users. The service entity can include, for example, a transportation service network provider. Communications associated with one or more of the backend services can be provided, transmitted, obtained, etc. via the service interface 145.

By way of example, the vehicle 105 can be used as part of a fleet of vehicles (e.g., autonomous vehicles, etc.) that provide vehicle services. The vehicle services can include user transportation services, delivery services (e.g., of item(s), etc.), courier services, etc. The remote computing system 150 can include, for example, a vehicle service arrangement service. The vehicle service arrangement service can be configured to arrange, for example, a vehicle service for a service request 155 associated with a user 160. An application running on a user device 165, of the user 160, can generate data indicative of the service request 155. The service request 155 can be based at least in part on user input that identifies, for example, a type of service, a pickup location, a drop-off/destination location, user preferences/accommodations, etc. The user device 165 can communicate data indicative of the service request 155 to the remote computing system 150. The remote computing system 150 can generate a service assignment for a vehicle service. The service assignment can be indicative of a type of service, location(s) associated with the requested vehicle service, an associated user, user preferences/accommodations, etc. Data indicative of the service assignment can be communicated to the vehicle computing system 110 via the service interface 145. Data indicative of a confirmation of the vehicle 105 assigned to the service request 155 of the user 160 can be communicated from the remote computing system 150 to the user device 165. The user device 165 can be configured to present a user interface via a display device. This can include, for example, the user interface(s) further described herein.

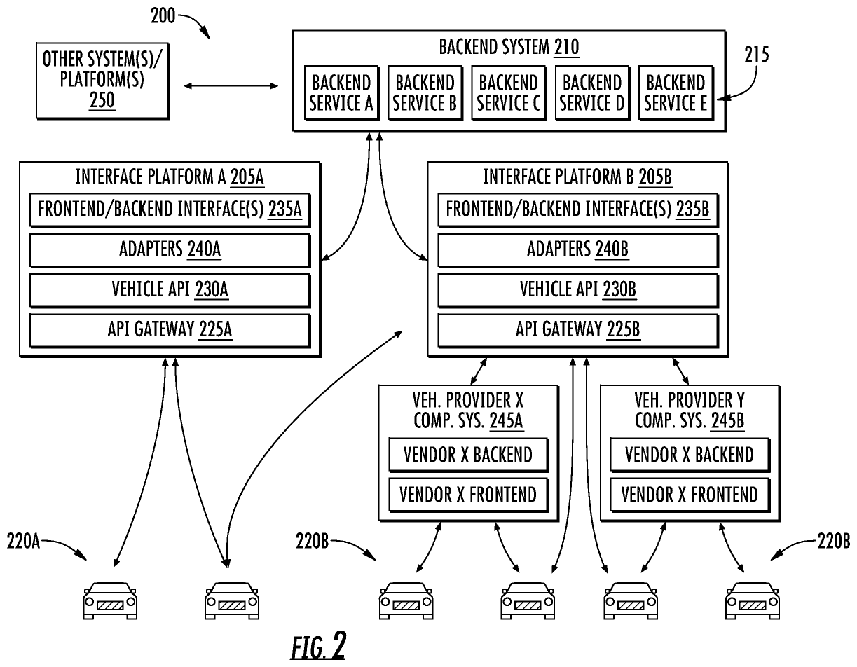

FIG. 2 depicts a block diagram of an example service infrastructure 200 of an example platform according to example embodiments of the present disclosure. The service infrastructure 200 can include one or more systems, interfaces, and/or other components that can be included in an operations computing systems of a service entity for coordinating vehicle services and managing/supporting the autonomous vehicle associated therewith. The service infrastructure 200 can represent, for example, the architecture of a service platform of the operations computing system for coordinating and providing one or more vehicle services (e.g., via autonomous vehicle(s), etc.).

The service infrastructure 200 of an operations computing system can include a first application programming interface platform 205A, a second application programming interface application platform 205B, and/or a backend system 210 with one or a plurality of backend services 215. These components can allow the service infrastructure 200 (e.g., the operations computing system) to communicate with one or more autonomous vehicles and/or one or more other systems.

The first application programming interface platform 205A can facilitate communication with one or more autonomous vehicles of the service entity. For example, as described herein, the service entity may own, lease, etc. a fleet of autonomous vehicles 220A that can be managed by the service entity (e.g., its backend services) to provide one or more vehicle services. The autonomous vehicle(s) 220A can be utilized by the service entity to provide the vehicle service(s) and can be included in the fleet of the service entity. Such autonomous vehicle(s) may be referred to as “service entity autonomous vehicles” or “first party autonomous vehicles.”

The first application programming interface platform 205A can include a number of components to help facilitate the support, coordination, and management of the first party autonomous vehicles 220A associated with the service entity. The first application programming interface platform 205A (e.g., a private platform, etc.) can provide access to one or more backend services 215 that are available to the first party autonomous vehicles 220A. To help do so, the first application programming interface platform 205A can include a first API gateway 225A. The first API gateway 225A can function as a proxy for application programming interface (API) calls and can help to return an associated response. The first API gateway 225A can help provide other support functions for the service infrastructure 200 such as, for example, authentication functions, etc.

The first application programming interface platform 205A can include one or more APIs such as, for example, a first vehicle API 230A. The vehicle API 230A can include a library and/or parameters for facilitating communications between the first party autonomous vehicles 220A and the backend service(s) 215 of the backend system 210. For example, the first vehicle API 230A can be called by a first party autonomous vehicle 220A and/or another system (e.g., system(s)/platform(s) 250) to help communicate data, messages, etc. to and/or from an autonomous vehicle and/or another system (e.g., system(s)/platform(s) 250). The first vehicle API 230A can provide for communicating such information in a secure, bidirectional manner that allows for expanded processing of data offboard a vehicle, analyzing such data in real time, and/or the like.

The first application programming interface platform 205A can include first frontend/backend interface(s) 235A. Each first frontend/backend interface 235A can be associated with a backend service 215 of the backend system 210. The first frontend/backend interface(s) 235A can serve as interface(s) for one client (e.g., an external client such as a first party autonomous vehicle 220A) to provide data to another client (e.g., a backend service 215). In this way, the frontend/backend interface(s) 235A can be external facing edge(s) of the first application programing interface platform 205A that are responsible for providing secure tunnel(s) for first party autonomous vehicles 220A (and/or other system(s)/platform(s) 250) to communicate with the backend system 210 (and vice versa) so that a particular backend service can be accessed by a particular first party autonomous vehicle 220A (and/or other system(s)/platform(s) 250).

In some implementations, the first application programing interface platform 205A can include one or more first adapters 240A, for example, to provide compatibility between one or more first frontend/backend interfaces 235A and one or more of the API(s) associated with the first application programming interface platform 205A (e.g., vehicle API 230A). The first adapter(s) 240A can provide upstream and/or downstream separation between particular infrastructure components, provide or assist with data curation, flow normalization and/or consolidation, etc.

The second application programming interface platform 205B (e.g., a public platform, etc.) can facilitate communication with one or more autonomous vehicles of a third party vehicle provider. As described herein, a third party vehicle provider can be an entity that makes one or more of its autonomous vehicles available to the service entity for the provision of vehicle services. This can include, for example, an individual, an original equipment manufacturer (OEM), a third party vendor, or another entity that places its autonomous vehicle(s) online with the service platform of the service entity such that the autonomous vehicle(s) can provide vehicle services of the service entity. These autonomous vehicles may be referred to as “third party autonomous vehicles” and are shown in FIG. 2 as third party autonomous vehicles 220B. Even though such autonomous vehicles may not be included in the fleet of autonomous vehicles of the service entity, the service infrastructure 200 (e.g., of the service entity's service platform, etc.) can allow the third party autonomous vehicles 220B to provide vehicle services offered by the service entity, access the one or more backend services 215 of the backend system 210, etc.

The second application programming interface platform 205B can allow the service platform to communicate directly or indirectly with autonomous vehicle(s). In some implementations, a third party autonomous vehicle 220B may call an API of, send data/message(s) to receive data/message(s) from/directly through, etc. the second application programming interface platform 205B.

Additionally, or alternatively, another computing system can serve as an intermediary between the third party autonomous vehicles 220B and the second application programming interface platform 205B (and the service platform associated therewith). For example, the service infrastructure 200 can be associated with and/or in communication with one or more third party vehicle provider computing systems 245, such as a vehicle provider X computing system 245A and a vehicle provider Y computing system 245B. Each third party vehicle provider X, Y can have its own, separate third party autonomous fleet including respective third party autonomous vehicles 220B. The third party vehicle provider computing systems 245A-B can be distinct and remote from the service infrastructure 200 and provide for management of vehicles associated with that particular third party vehicle provider. As shown in FIG. 2, a third party vehicle provider computing system 245A-B can include its own backends and/or frontends for communicating with other systems (e.g., third party autonomous vehicle(s) 220B, operations computing system, etc.).

The third party computing system 245A-B associated with a particular third party autonomous vehicle fleet can serve as the communication intermediary for that fleet. For example, third party autonomous vehicles 220B associated with third party vehicle provider X can communicate with the third party vehicle provider X computing system 245A which can then communicate with the service infrastructure 200 (e.g., to access the available backend services 215, etc.) via the second application programming interface platform 205B. Data from the service infrastructure 200 (e.g., the backend services 215, etc.) can be communicated to the vehicle provider X computing system 245A (e.g., via the second application programming interface platform 235B, etc.) and then to the third party autonomous vehicles 220B associated with third party vehicle provider X. In another example, third party autonomous vehicles 220B associated with third party vehicle provider Y can communicate with the third party vehicle provider Y computing system 245B which can then communicate with the service infrastructure 200 (e.g., to access the available backend services 215, etc.) via the second application programming interface platform 205B. Data from the service infrastructure 200 (e.g., the backend services 215, etc.) can be communicated to the third party vehicle provider Y computing system 245B (e.g., via the second application programming interface platform 205B, etc.) and then to the third party autonomous vehicles 220B associated with third party vehicle provider Y.

The second application programming interface platform 205B can include a number of components to help facilitate the support, coordination, and management of the third party autonomous vehicles 220B associated with the third party vehicle providers. The second application programming interface platform 205B can provide access to one or more backend services 215 that are available to the third party autonomous vehicles 220B. To help do so, the second application programming interface platform 205B can include a second API gateway 225B. The second API gateway 225B can function as a proxy for application programming interface (API) calls and can help to return an associated response. The second API gateway 225B can help provide other support functions for the service infrastructure 200 such as, for example, authentication functions, etc.

The second application programming interface platform 205B can include one or more APIs such as, for example, a second vehicle API 230B. The second vehicle API 230B can include a library and/or parameters for facilitating communications between the third party autonomous vehicles 220B and the backend service(s) 215 of the backend system 210. For example, the second vehicle API 230B can be called by a third party autonomous vehicle 220B and/or another system (e.g., a third party vehicle provider computing system 245, etc.) to help communicate data, messages, etc. to and/or from an autonomous vehicle. The second vehicle API 230B can provide for communicating such information in a secure, bidirectional manner.

The second application programming interface platform 205B can include second frontend/backend interface(s) 235B. Each of the second frontend/backend interface(s) 235B can be associated with a backend service 215 of the backend system 210. The second frontend/backend interface(s) 235B can serve as interface(s) for one client (e.g., an external client such as a third party autonomous vehicle 220B, a third party vehicle provider computing system 245A-B, etc.) to provide data to another client (e.g., a backend service 215, etc.). In this way, the second frontend/backend interface(s) 235B can be external facing edge(s) of the second application programing interface platform 205B that are responsible for providing secure tunnel(s) for third party autonomous vehicles 220B (and/or other intermediary systems) to communicate with the backend system 210 (and vice versa) so that a particular backend service 215 can be utilized. In some implementations, the second application programing interface platform 205B can include one or more second adapters 240B, for example, to provide compatibility between one or more second frontend/backend interfaces 235B and one or more of the API(s) associated with the second application programming interface platform 205B (e.g., vehicle API 230B, etc.).

In some implementations, the first party autonomous vehicles 220A can utilize the second application programming interface platform 205B to access/communicate with the service platform/backend service(s) 215. This can allow for greater accessibility and/or back-up communication options for the first party autonomous vehicles 220A.

The backend system 210 can host, store, execute, etc. one or more backend services 215. The backend service(s) 215 can be implemented by system client(s), which can include hardware and/or software that is remote from the autonomous vehicles and that provide a particular service to an autonomous vehicle. The backend service(s) 215 can include a variety of services that help coordinate the provision of vehicle service(s) and support the autonomous vehicles and/or the third party vehicle providers performing/providing those vehicle service(s).

For example, the backend service(s) 215 can include a matching service that is configured to match an autonomous vehicle and/or an autonomous vehicle fleet with a service request for vehicle services. Based on a match, the matching service can generate and communicate data indicative of a candidate vehicle service assignment (indicative of the requested vehicle service) for one or more autonomous vehicles. In some implementations (e.g., for first party autonomous vehicle(s) 220A, etc.), the candidate vehicle service assignment can include a command that a first party autonomous vehicle 220A is required to accept, unless it would be unable to safely or fully perform the vehicle service. In some implementations (e.g., for third party autonomous vehicle(s) 220B, etc.), the candidate vehicle service assignment can include a request or offer for one or more autonomous vehicles to provide the vehicle service. The candidate vehicle service assignment can be communicated to one or more third party vehicle provider computing systems 245 and/or one or more autonomous vehicle(s) 220B (e.g., via the interface platform B 205B, etc.) and/or one or more autonomous vehicle(s) 220A (e.g., via the first interface platform 205A, etc.). The candidate vehicle service assignment can be accepted or rejected. If accepted, an autonomous vehicle 220A, 220B can be associated (e.g., assigned to service, etc.) with the vehicle service assignment. The vehicle service assignment can include data indicative of the user, a route, an origin location for the vehicle service, a destination location for the vehicle service, service parameters (e.g., time restraints, user accommodations/preferences, etc.), and/or any other information associated with a vehicle service.

The backend service(s) 215 can include an itinerary service. The itinerary service can be configured to maintain, update, track, etc. a data structure indicative of one or more task(s) and/or candidate task(s) associated with (and/or potentially associated with) a particular autonomous vehicle, autonomous vehicle fleet, and/or vehicle provider. The tasks can include, for example, vehicle service assignments for providing vehicle services and/or tasks associated with an activity other than the performance of a vehicle service. For example, the tasks can include: a testing task (e.g., for testing and validating autonomy software, hardware, etc.); a data acquisition task (e.g., acquiring sensor data associated with certain travel ways, etc.); a re-positioning task (e.g., for moving an idle vehicle between vehicle service assignments, to high demand areas, etc.); a circling task (e.g., for travelling within the current geographic area in which a vehicle is located (e.g., circle the block or neighborhood), etc.); a maintenance task (e.g., for instructing travel to a service depot to receive maintenance, etc.); a re-fueling task; a vehicle assistance task (e.g., where a vehicle travels to assist another vehicle, etc.); a deactivation task (e.g.. going offline such that a vehicle, fleet of vehicles, or vehicle providers no longer accept service request, etc.); a parking task; and/or other types of tasks. The itinerary service can maintain an itinerary for an autonomous vehicle, fleet, vehicle provider, etc. The itinerary can serve as a queue for the various tasks. In some implementations, the tasks can be associated with a priority or order for which they are deployed to an autonomous vehicle, fleet, vehicle provider, etc.

In some implementations, the vehicle service assignment can be associated with a multi-modal vehicle service. For example, the user may request and/or be provided a multi-modal user itinerary by which the user is to travel to the user's ultimate destination via two or more types of transportation modalities (e.g., ground based vehicle, aerial vehicle, public transit, etc.). As such, the origin location and/or destination location identified in the vehicle service assignment may include intermediate locations (e.g., transfer points) along the user's multi-modal itinerary.

The backend service(s) 215 can include a deployment service that communicates tasks for an autonomous vehicle to complete. For example, the deployment service can communicate data indicative of a vehicle service assignment and/or another task to an autonomous vehicle (or an intermediary system). The deployment service can communicate such data to an autonomous vehicle (or an intermediary system) based at least in part on the itinerary associated therewith. By way of example, the highest priority task and/or the task that is next in order can be deployed.

The backend services 215 can include a routing service. The routing service can be configured to provide an autonomous vehicle with a route for a vehicle service and/or another task. The route can be based at least in part on factors associated with the geographic area in which the autonomous vehicle is (or will be) travelling (e.g., roadways, weather, traffic, events, etc.). Additionally, or alternatively, the route can be based at least in part the autonomy capabilities of the autonomous vehicle (e.g., ability to complete an unprotected left-hand turn, U-turn, etc.). In some implementations, the routing service can be configured to assign, coordinate, monitor, adjust, etc. one or more designated pick-up and/or drop-off zones for the vehicle service(s). The routing service can be available to first party autonomous vehicles 220A. In addition, or alternatively, the routing service can be available to third party autonomous vehicles 220B if permitted/requested by an associated third party vehicle provider.

The backend services 215 can include a user experience service. The user experience service can be configured to communicate data to a user associated with the vehicle service. This can include, for example, upcoming vehicle actions, routes, drop-off zones, user adjustable vehicle conditions (e.g., music, temperature, etc.). Such information can be presented via a display device of an onboard tablet associated with an autonomous vehicle, a user device associated with the user, etc. through a software application associated with the service entity. The user experience service can be one example backend associated with the provision of payloads and user interfaces for a user device.

The backend services 215 can include a remote assistance service. The remote assistance service can be configured to provide remote assistance to an autonomous vehicle and/or a user (e.g., a passenger associated with the vehicle service, etc.). For example, a remote assistance operator can take over control of one or more vehicle operations and/or otherwise assist an autonomous vehicle during the one or more vehicle operations. By way of example, a remote assistance operator can remotely control the navigation of an autonomous vehicle to navigate the vehicle around/past an unexpected obstruction in a travel way (e.g., a fallen tree, etc.). In another example, the remote assistance operator can communicate with a user (e.g., via the onboard tablet, user's phone, etc.) in the event that the user is in need of help. Additionally, or alternatively, the remote assistance service can be configured to monitor/listen for various vehicle state changes and provide data payloads associated therewith to a user device of a user, as described herein. This can allow for the updating of user interfaces and/or the generation of new user interfaces for the user in accordance with the technology of the present disclosure.

The backend services 215 can include a simulation/testing service. The simulation/testing service can help facilitate vehicle provider integration with the service platform. For example, simulation/testing service can provide testing environments for vehicle providers to simulate communications and/or the performance of vehicle services using the service infrastructure 200.

The backend services 215 can include one or more other services. This can include, for example, payment services, vehicle rating services, health and maintenance services, software update/deployment services, and/or other services.

In some implementations, one or more backend services 215 that are available to the first party autonomous vehicles 220A (e.g., via the first application programming interface platform 205A) may not be available to the third party autonomous vehicles 220B (e.g., via the second application programming interface platform 205B), and vice versa. For example, a software update/deployment service for the first party autonomous vehicles 220A may not be accessible or suitable for a third party autonomous vehicle 220B that utilizes the onboard autonomy software of a third party vehicle provider (not the service entity). As such, a software update/deployment backend service may not be able to communicate with a third party autonomous vehicle 220B and/or vice versa.

In some implementations, the service infrastructure 200 can include a test platform for validating and vetting end-to-end platform functionality, without use of a real vehicle on the ground. For example, the test platform can simulate trips with human drivers and/or support fully simulated trip assignment and/or trip workflow capabilities. For example, the test platform can simulate and monitor data traffic through the service infrastructure 200 to ensure proper functioning. In some implementations, the testing platform can access the simulation/testing backend to help facilitate a test or simulation.

In some implementations, the service infrastructure 200 can utilize a plurality of software development kits (SDKs) that help provide access to the first and second application programming interface platforms 205A, 205B. All (or a portion of) external communication with the platforms can be done via the SDKs. For example, the SDKs can include a first SDK (e.g., private SDK) and a second SDK (e.g., public SDK) and specific endpoints to facilitate communication with the first and second application programming interface platforms 205A, 205B, respectively. In some implementations, the first party autonomous vehicle(s) 220A (and/or a test platform) can use both the first and second SDKs, whereas the third party autonomous vehicles 220B and/or the third party vehicle provider computing systems 245A-B can use only the second SDK and associated endpoints. In some implementations, the SDKs can provide a single entry point, which can improve consistency across both the service provider fleet and the third party entity fleet(s). As an example, a second SDK can provide secured access to the second application interface platform 205B and access to capabilities such as vehicle service assignments, routing, and/or the like. The first SDK can be accessed by the first party autonomous vehicles 205A and provide access to capabilities including those available only to the first party autonomous vehicles 205A.

In some implementations, the SDKs can include a command-line interface to provide an entry point into the SDK components and act as a gateway for SDK related work, integration, testing, and authentication. For example, the command-line tools can provide for bootstrapping, managing authentication, updating SDK version, testing, debugging, and/or the like. In some implementations, a command-line interface can require an authentication certificate before being able to bootstrap an SDK, download components, and/or access a service entity's services. For example, based on the authentication certificate, a command-line interface can determine which version of the SDK to which to provide access. In some implementations, SDKs can be implemented onboard a first or third party autonomous vehicle 220A, 220B and/or a third party vehicle provider computing system 245A-B.

In some implementations, the service infrastructure 200 can facilitate communication between the service platform and one or more other system(s)/platform(s) 250 associated with the service entity/operations computing system. By way of example, the service entity may have (e.g., the operations computing system may include, etc.) one or more other system(s)/platform(s) 250 that can help indicate what services/vehicles are available to a user or other system, coordinate the provision of vehicle services by human-driven vehicles, and/or are specifically associated with certain types of services (e.g., food delivery services, etc.). The other system(s)/platform(s) 250 may communicate with the service platform utilizing the service infrastructure 200 (e.g., interface platform 205A, etc.) to determine, for example, whether any autonomous vehicles would be available to the user for any potential vehicle services that may be requested via a software application of the service entity.

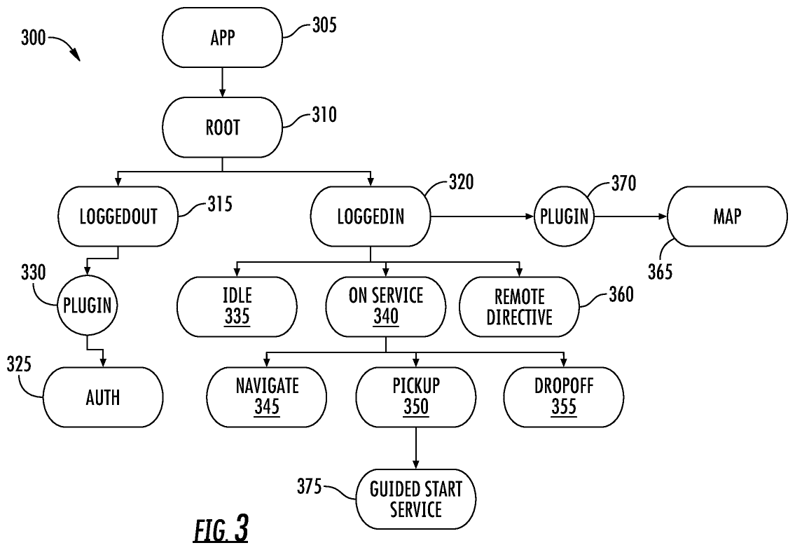

FIG. 3 depicts a state diagram of an example service flow 300 for an application 305 according to example embodiments of the present disclosure. The application 305 can be downloaded and run on a user device. In some implementations, the application 305 can be utilized for requested a vehicle service. In some implementations, the application 305 can be utilized with a user device of the vehicle for users that have been assigned the vehicle for a requested vehicle service.

The service flow 300 can include a variety of scopes/states of the application 305. For example, the application 305 can include a scope/state for application initialization. The service flow 300 can include a root scope/state 310 that switches between a loggedout scope/state 315 and a loggedin scope/state 320. This can depend, for example, on whether the user has an authentication token. The root scope/state 310 can also be responsible for loading experiment(s) after user login has succeeded but before attaching the loggedin scope/state 320.

The loggedout scope/state 315 can cause the application 305 to display (e.g., via a user interface, etc.) a login experience. This can include a username-password based log-in interface. In some implementations, a plugin point can be hosted to enable one or more changes to the login screen. An authentication scope/state 325 can be associated with authentication of a user or another party associated with a vehicle service. In some implementations, the authentication scope/state 325 can be behind a plugin point 330.

The loggedin scope/state 320 can be attached, for example, when the application 305 has a valid authentication token and information has finished loading for the current session. Once logged-in, for example, the application 305 can start receiving status updates, data payloads, etc. associated with a vehicle (e.g., autonomous vehicle) that inform the application 305 of next steps.

From the user application's perspective, there can be a plurality of high level scopes/states associated with the status of a vehicle. These can be child scopes/states for the loggedin scope/state 320. For example, there can be an idle scope/state 335, which can include states before and after the service, and/or error states. In some implementations, there can be logging and debugging associated with the idle scope/state 335. Additionally, or alternatively, there can be an on-service scope/state 340. The on-service scope/state 340 can be associated with a vehicle service being assigned to a vehicle as well as details about the user's service (e.g., destinations, vehicle progress, etc.). In some implementations, the on-service scope/state 340 can be associated with a user being present in a vehicle. Thus, the application 305 can display (e.g., via a display device of a user device, etc.) user interfaces associated with the service flow 300 while the service is being performed and, in some implementations, to allow a user to make changes to the service. For example, the service flow 300 can include a navigate scope/state 345 (e.g., associated with vehicle navigating to a location, etc.), a pickup scope/state 350 (e.g., associated with the vehicle picking up the user and/or item for a vehicle service), a drop-off scope/state 355 (e.g., associated with the vehicle dropping of the user and/or item for a vehicle service), etc. These scopes/states can cause the display of different user interfaces and/or changes to a user interface via the application 305 depending on the status of the vehicle and/or the vehicle service.

In some implementations, a remote directive scope/state 360 can be included. This can be associated with, for example, a remote instruction being sent to the vehicle (e.g., a pull-over instruction, parking instructions, updated route, maintain stopped status, etc.).

In some implementations, the loggedin scope/state 320 can be associated with a map scope/state 365. The map scope/state 365 can be used, for example, to load a map and display the map via a user interface while the user and/or the vehicle is on service. In some implementations, the map scope/state 365 can be behind a plugin point 370.

The service flow 300 can also include a guided start service scope/state 375. This scope/state can be associated with the user-assisted initiation of a vehicle service and vehicle motion associated therewith.

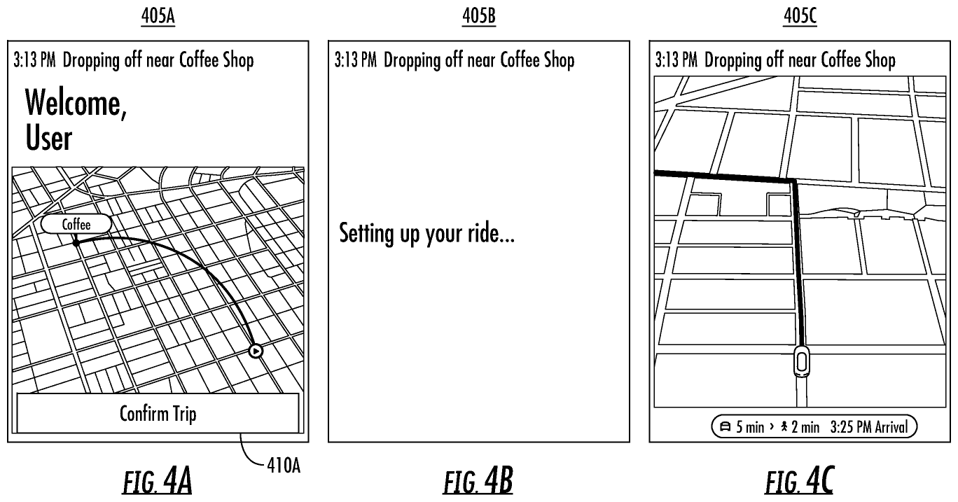

For example, FIGS. 4A-C depicts an example user interface flow according to example embodiments of the present disclosure. For example, after requesting a vehicle service, an application running on a user device can provide a user interface 405A for display via a display device of the user device. The user interface 405A can be or otherwise include a service confirm user interface. The user interface can include a confirmation element 410A, as shown in FIG. 4A, that allows the user to confirm (e.g., through touch, voice, click, etc. interaction with the element) the service. Data indicative of the user's confirmation of the service can be communicated to a backend service of a service platform for the coordination of the requested vehicle service. This can include the determination and selection of a vehicle (e.g., an autonomous vehicle, etc.) for the particular service (e.g., user transportation, delivery, etc.). In some implementations, a user interface 405B of FIG. 4B can be displayed to indicate to the user that the service is being coordinated by the service entity. User interface 405C can be utilized to show the progress of an assigned vehicle as it travels to a location associated with the vehicle service.

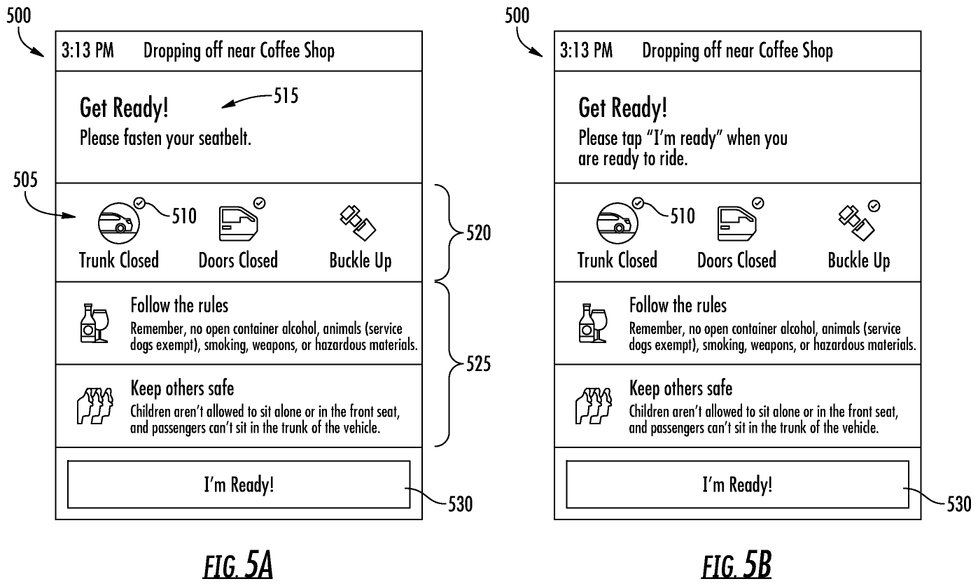

As part of the user guided start service, the user can be presented with a service a service condition checklist user interface 500, as shown in FIGS. 5A and 5B. The application running on the user device can provide data indicative of the service condition checklist user interface 500 for display via a display device (e.g., screen, etc.) of the user device. The service condition checklist user interface 500 can display one or more service condition items 505 and/or a status 510 of the one or more service condition items to the passenger. In some implementations, the service condition item(s) 505 can include conditions that must be satisfied for the vehicle and/or the user(s) to be placed into appropriate condition for a service. The service condition item(s) 505 and/or the statuses 510 can be presented via text, icon, etc. The service condition item(s) 505 and/or the statuses 510 can change (e.g., color, appear/disappear, icon/text change, etc.) as tasks associated therewith are completed, updated, etc.

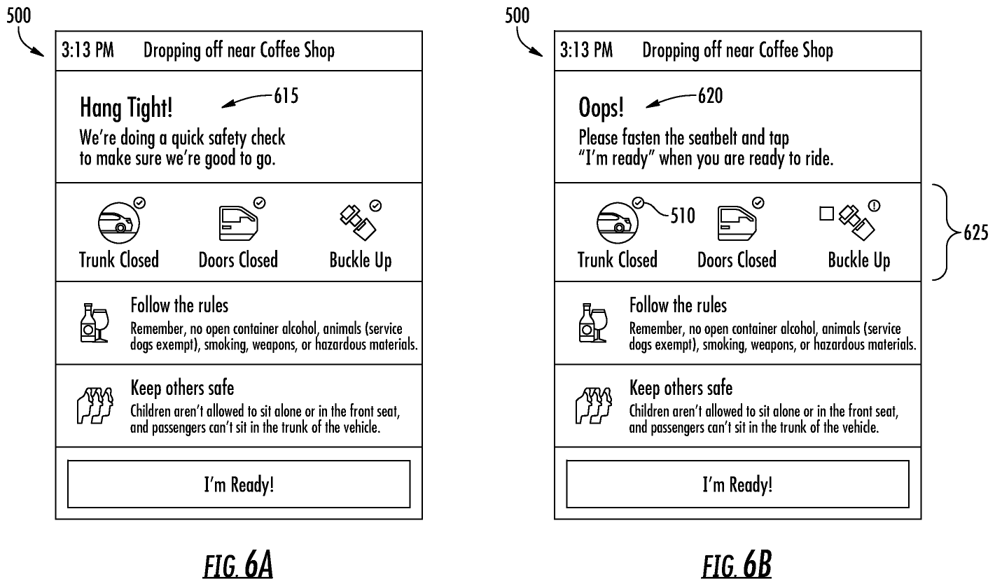

In some implementations, the service condition checklist user interface can include an action header element 515. The action header element 515 can inform the user of any action that is urgent, immediate, critical, and/or otherwise of interest to be taken by the user. As one example, the action header element 515 can display directive text such as “Get Ready!” and/or other text/icon instructing the user to perform some action, such as text/icon instructing the user to interact with a user interface element to indicate readiness, text/icon instructing the user to fasten his or her seatbelt, text/icon instructing the user to secure an item in and/or to the vehicle, text/icon instructing the user to close and/or secure vehicle doors, text/icon instructing the passenger to close and/or secure a vehicle trunk, and/or other suitable directive text. Additionally and/or alternatively, the action header element 515 can inform the user if no further action is currently required on the part of the user. As one example, shown in FIG. 6A, the action header element 615 of user interface 500 can display text such as “Hold on!” or “Hang tight!” and/or text informing the user that the status of the vehicle is pending confirmation.

With reference again to FIG. 5A-B, the service condition checklist user interface 500 can additionally, or alternatively, include a hardware state checklist element 520. the hardware state checklist element 520 can display a checklist of action items to the user in a concise, graphical form. As an example, the hardware state checklist element 520 can include, for at least some of the service condition items, an icon representing the service condition item 505, a concise (e.g., in fewer than five words, etc.) description of the service condition item 505, and/or a concise and/or graphical depiction of the status 510 of the service condition item (e.g., a check icon representing that the item is satisfied, etc.). In some implementations, for example, the hardware state checklist item 520 can provide information for a subset of the service condition items 505 such as, for example, a doors closed condition, a trunk closed condition, and/or a seatbelts fastened condition.

Additionally and/or alternatively, the service condition checklist user interface 500 can include a rules list element 525. The rules list element 525 can display a list of rules to the user. In some implementations, the rules list element 525 can be wordier than the hardware state checklist element 520 (e.g., on the order of ten to twenty words per rule, etc.). As an example, the rules list element 525 can include, for at least some of the rules, an icon representing the rule, a title of the rule, and/or a short description of the rule. As one example, the rules can include restrictions on items such as alcohol, firearms, hazardous materials, drugs, tobacco products, and/or other items. As another example, the rules can include restrictions on the placement of children within the vehicle, such as limiting children to the back seat. As another example, the rules can include a requirement that seatbelts remain fastened while the vehicle is in motion, until the service is completed, etc. The rules may or may not be verified by service condition item(s) 505 directly. In some implementations, one or more of the rules can be verified by a remote operator when the user(s) have indicated readiness for the service.

Additionally and/or alternatively, the service condition checklist user interface 500 can include a user ready element 530. The user can interact with the user ready element 530 to indicate that the user and/or item is ready for the service (e.g., to be transported to a destination, etc.). As an example, the user ready element 530 can include a button, toggle, and/or other interactable element. In some implementations, the user ready element 530 can display functional text, such as “I'm ready” or “Start service” or other suitable text/icon indicating function of the user ready element 530. The user can be restricted from interacting with, and/or causing input through, the user ready element 530 until the service condition items 505 are satisfied. For instance, the user can be restricted from interacting with the passenger ready element by “graying out” or hiding the passenger ready element until the service condition items 505 are met, as shown in FIG. 5A. In response to all the service conditions 505 being satisfied, the user ready element 530 can become enabled for interaction by the user. This can include the user ready element 530 appearing in the user interface or being selectable by the user (e.g., no “grayed out”, etc.), as shown in FIG. 5B.

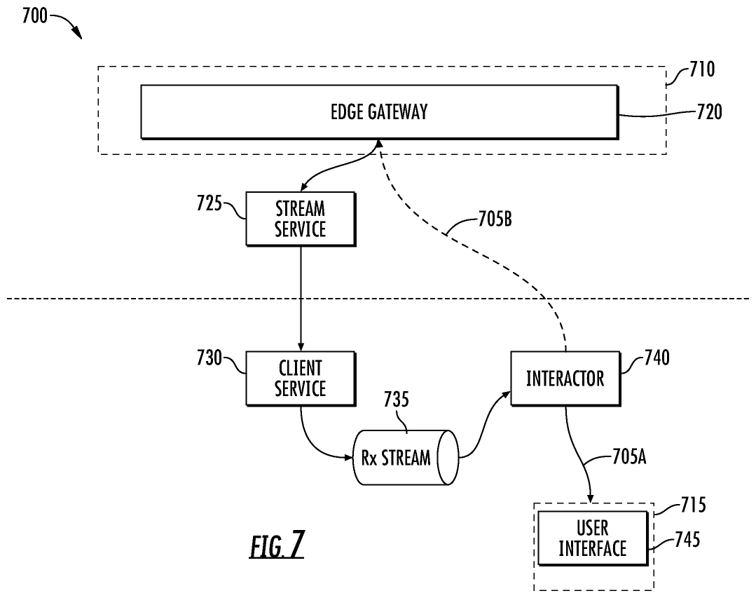

The action header element 515, hardware state checklist element 520, rules list element 525, and/or other elements of the service condition checklist user interface 500 (or another user interface) can be populated on an application (e.g., a user interface thereof) of a client device based on data from a server computing system. For example, FIG. 7 depicts a block diagram of an example vehicle state payload flow 700 according to example embodiments of the present disclosure. For instance, the elements of the service condition checklist user interface 500 can be populated with data from a vehicle state payload 705A delivered (e.g., periodically, etc.) from a server computing system 710 (e.g., of backend system 210, etc.) to the client device 715. The vehicle state payload 705A (e.g., a first vehicle state payload) can include data and/or information associated with a particular state. Additionally and/or alternatively, a similarly and/or identically structured vehicle state payload 705B (e.g., a second vehicle state payload, etc.) can be delivered from the client device 715 to the server computing system 710.

As shown in FIG. 7, the vehicle state payload flow 700 can involve a number of components. For instance, the server computing system 710 can include and/or otherwise be associated with a gateway 720 (e.g., an edge gateway, etc.). Data can flow through a streaming service 725 and a client service 730. Data can be emitted onto an Rx stream 735, which can be dependency injected into an interactor 740, where it can be subscribed to a data source to adjust the user interface 745 (e.g., a user interface as described herein, etc.).

By way of example, the vehicle state payload 705A/B can be and/or can include at least one service blocking item data structure. The service blocking item data structure can represent a condition item that blocks the vehicle from performing a service. The service blocking item data structure can include one or more values. As one example, the service blocking item data structure can include a name. The name can be, for example, a string. Additionally and/or alternatively, the service blocking item data structure can include an icon reference. The icon reference can be, for example, a URL. The icon reference can provide a reference to an icon representing the service blocking item. Additionally and/or alternatively, the service blocking item data structure can include a status. The status can represent a status of the service block item. In some implementations, values of the status can be selected from one of an invalid status, a to-be-addressed status, an addressed status, a warning status, and/or another statue. Service blocking items having a warning status can have a warning severity. In some implementations, the warning severity can be indicative that the action is provided only as a warning and will not prohibit the service if unaddressed.

In some implementations, the vehicle state payload 705A/B can include a list of service blocking items. Additionally and/or alternatively, the vehicle state payload 705A/B can be transmitted in response to unblocking a specific item in the list of service blocking items. For instance, the vehicle state payload 705A/B can include a task identifier. The task identifier can identify a task that is specific to the vehicle state payload 705A/B. For example, the task identifier can be a numeric value, such as an integer, a string, and/or any other suitable value(s). Additionally and/or alternatively, the vehicle state payload 705A/B can include an action title. The action title can be a title of a primary action to unblock. For example, the action title can be a numeric value, such as an integer, a string, and/or any other suitable value(s). Additionally and/or alternatively, the vehicle state payload 705A/B can include an action description. The action description can be a description of a primary action to unblock. As an example, the action description can be a string.

For instance, a backend (e.g., of the server computing system 710) can dynamically generate a vehicle state payload 705A/B of service blocking items. The vehicle state payload 705A/B can represent items that would block (e.g., prevent, prohibit, etc.) a vehicle (e.g., an autonomous vehicle, etc.) from operating normally, safely on a service and/or otherwise initiating motion in accordance with a vehicle service. The vehicle state payload 705A/B can be pushed from the gateway 710 at the backend, which can be received by the client service 730 (e.g., a RaMEN client, etc.), as shown in FIG. 7.

The vehicle state payload 705A/B can be triggered by one or more events within a service. As one example, the vehicle state payload 705A/B can be triggered when a user has been identified (e.g., via an application, etc.), such as when the user requests a vehicle service (e.g., a user transportation service, delivery service, etc.). For instance, in some implementations, an itinerary report listener (e.g., a Kafka topic or similar listener service, etc.) can listen to an itinerary service on the backend. The itinerary service can advance a vehicle service status to a pickup status for a vehicle when a user requests a service and has been assigned the vehicle. When the itinerary report listener detects that the vehicle service state has advanced to the pickup task, the itinerary report listener can trigger a call to push the vehicle state payload 705A/B to the application of the client device 715. As another example, in some implementations, the vehicle state payload 705A/B can be triggered throughout the vehicle service itself. For instance, a vehicle service state listener (e.g., a Kafka topic or similar listener service, etc.) can listen to the itinerary service for state changes in the vehicle service state. When the vehicle service state listener detects that the vehicle service state has changed during a vehicle service, the vehicle service state listener can trigger a call to push the vehicle state payload 705A/B to an application of the client device 715. For example, the vehicle service state listener can listen for changes to door state, trunk state, seatbelt state, or other states related to service blocking items. Such changes can be detected based at least in part on sensor data associated with those components. The vehicle computing system can detect the change based on the sensor data and send an indication of the event to the listener and/or provide the sensor data for event detection offboard the vehicle. As another example, a vehicle verification listener (e.g., a Kafka topic or similar listener service, etc.) can listen for completion of a vehicle verification (e.g., through a cabin check service, remote assistance service, etc.). When the vehicle verification listener detects a completed vehicle verification (e.g., a cabin check, etc.), the vehicle verification listener can call to push the vehicle state payload 705A/B to the application of the client device 715.

In some implementations, a single listener (e.g., a single Kafka topic, etc.) can listen for all states. In some implementations, a separate listener (e.g., a unique Kafka topic, etc.) can listen for a particular state. Including multiple listeners for each state can, in some cases, improve scalability and/or reduce bandwidth.

In some implementations, the backend can be implemented at least partially using a push architecture wherein, when a client requests data by a call (e.g., an RPC call, etc.) from a server computing system 710, the data can be pushed to the server computing system 710 as a request. The result of the request can be sent back to the client as a response. The push architecture can be beneficial, as the vehicle state changes can be addressed as soon as they are changed. As another example, in some implementations, the backend can be implemented at least partially using a pull architecture, wherein the server computing system 710 can request data through an intermediate queue service. The queue service can forward the request from the server to the appropriate client.

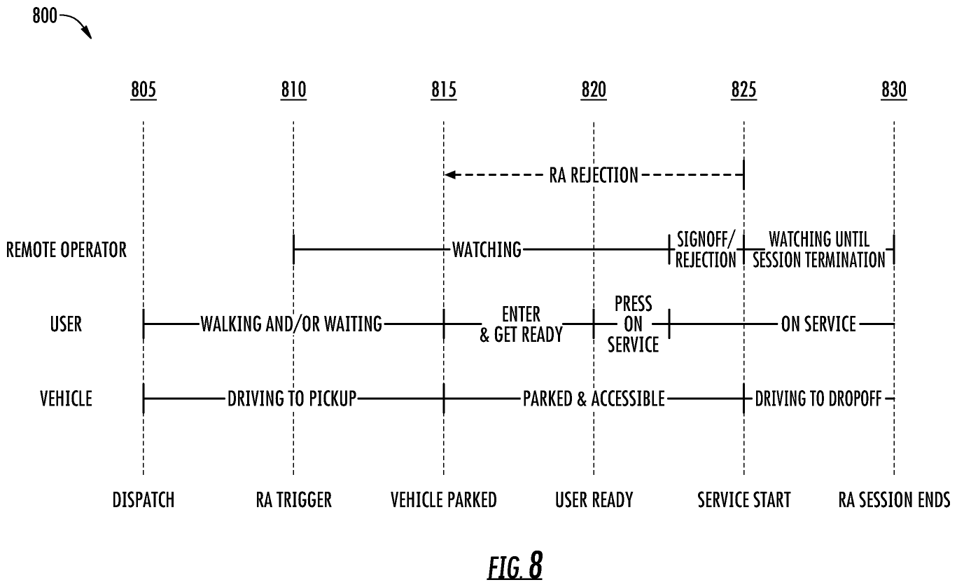

FIG. 8 depicts a timing diagram 800 of an example service flow according to example embodiments of the present disclosure. This timing diagram 800 can illustrate the user, vehicle, and/or backend service interplay for a vehicle service according to the present disclosure. The backend service can be, for example, a user experience and/or remote assistance service. A remote operator can be associated with the backend service.

A user can operate a user device (e.g., a laptop computer, desktop computer, mobile phone, smartphone, tablet computer, wearable device, etc.). The user can open an application on the user device. The application can provide for the user to request a vehicle service by a vehicle (e.g., autonomous vehicle, etc.). The service request can be processed and a vehicle can be assigned to the service request and deployed, at a first time 805. For example, the vehicle can be deployed to a pick-up location associated with the vehicle service (e.g., to pick-up the user, a food item for delivery, etc.). This can be the current location of the user, where the user can wait. In some implementations, the pick-up location can be a location that is different than the current location of the user (e.g., a designated pick-up/drop-off zone, etc.) and the user may walk to such a location. A service state associated with the application on the backend can be updated to a pickup status. The service state update can trigger the itinerary report listener to call for the user of the service to be verified.

At a second time 810 (e.g., while the vehicle is travelling to pick-up the user and/or an item, while the user is waiting/walking, etc.), a backend service can be triggered. This can result in a remote assistance operator associated with the vehicle and/or user to monitor the progress of the vehicle. In some implementations, the remote assistance operator can monitor the location of the user and assist with rendezvous between the user and the vehicle, if needed.

At a third time 815, the vehicle can arrive at the pick-up location and park at or nearby the pickup location (e.g., within a threshold walking distance, etc.). The vehicle can become accessible by, for example, unlocking its doors for the user. This can occur when the user is within a threshold distance of the vehicle as determined, for example, by near-field communication between the vehicle and the user device of the user.

The user can enter the vehicle and/or place an item inside the vehicle (e.g., for a delivery service, courier service, etc.). The user can be presented with a confirm service user interface, as described herein, via the application running on the user device of the user (e.g., which was used for requesting the vehicle service, etc.) and/or via an application running on a user device within, associated with, affixed to, etc. the interior of the vehicle (e.g., an onboard tablet that is intended for use by users of the vehicle for a vehicle service, etc.). The passenger can confirm that the information on the confirm service user interface is accurate. Additionally, the passenger can interact with the confirm service element to confirm the service.

The user can then be presented with the service condition checklist interface. Actions requiring the user's attention can be presented by the action header element. Additionally, the full list of requirements to begin the service can be displayed in the hardware state checklist element interface and/or the rules list. As the user makes changes to the state of the vehicle that produce meaningful vehicle state changes, an updated vehicle state payload can be pushed to the application such that the changes are reflected in the hardware state checklist, action header, etc. If, at a point in time, the user has conformed to the list of requirements (e.g., all doors are closed, the trunk is closed, at least one seatbelt is fastened, the item is secure/in a designated location, etc.) through interaction with the user interface, then the user can be presented with the user ready element, at a fourth time 820. Additionally and/or alternatively, the user ready element can be highlighted, made more visible in style, flashed between two or more colors, intensities, etc., and/or otherwise increased in visual awareness to the user in response to the list of requirements being satisfied.

Upon the user interacting with the user ready element, the user can be presented with a waiting interface that notifies the user to wait for some portion of time between the fourth time 820 and a fifth time 825. As one example, the action header element can be modified in the waiting user interface to instruct the user to wait (e.g., as shown in FIG. 6A). During this time, a remote operator can perform a vehicle verification, including e.g., remotely inspecting the state of the vehicle (e.g., autonomous vehicle, etc.) through one or more cameras, sensors, and/or other devices. The user may be made aware of the inspection of the remote operator, in some implementations.

The remote operator can approve the vehicle for the service and/or reject the vehicle for the service. If the remote operator approves the vehicle, a service state can progress and the user can be provided with an on-service interface detailing progress of the service (e.g., the progress of transporting the passenger to a destination). Additionally and/or alternatively, if the remote operator rejects the vehicle, the user can be provided with one or more interface elements that explain to the user the reason for rejection. For instance, commentary can be provided to the user (e.g., via the hardware state checklist element, etc.) indicating further actions the user can take to place the vehicle into condition for the service. This can include an action header element indicating such information such as, for example, the action header element 620 of FIG. 6B.

Returning to FIG. 8, in some implementations, once the vehicle verification has been successfully completed, the user can be enabled to begin the service. For instance, a successful completion of the vehicle verification can be reflected in a vehicle verification service. This can trigger a vehicle verification listener to call for a vehicle state payload to be pushed to the application. In some cases, this call can be agnostic to the trigger, so the entire vehicle state payload can be gathered and/or pushed. Additionally and/or alternatively, in some implementations, the backend can query an itinerary service to verify that the vehicle is still in the pickup state. Additionally and/or alternatively, in some implementations, the backend can query the vehicle verification service to verify that the vehicle verification was successful. Once these verifications have been completed, the vehicle verification service (e.g., of a remote assistance backend, etc.) can return whether or not the vehicle is in a service blocking state. Additionally, the backend can provide the application with the appropriate user interface to display. For instance, if the vehicle is not in a service blocking state, the backend can push a vehicle state payload with the user ready element enabled. If the vehicle is still in a service blocking state, the vehicle state payload can be pushed and the service blocking items can be displayed (e.g., via the hardware state checklist 625 of FIG. 6B, etc.) to the user.

At the fifth time 825 (or before the fifth time but after the fourth time 820), the vehicle service can begin. For example, once a vehicle verification indicates that all the service condition item(s) have been met, the vehicle can be provided with data indicating that the vehicle is to initiate motion for the vehicle service. This can include travelling away from a pick-up location, along a route, towards a destination location, etc. For example, the vehicle can begin to travel to a drop-off location associated with the vehicle service. This can include, for example, a location to drop-off an item and/or the user.

The remote operator (e.g., via a remote assistance backend service, etc.) can monitor the vehicle, the user, and/or an item until the end of the vehicle service. For example, while the vehicle service is underway, the user may cause changes to the state of the vehicle that could potentially return the vehicle to a service blocking state. To address this, a service state listener can listen to the service state to detect meaningful state changes that return the vehicle to a service blocking state. As one example, if the vehicle requires all doors of the vehicle to be closed to carry out the service, the service state listener may listen for state changes in door states of the vehicle to detect that a door has been opened. As another example, if the vehicle requires passenger(s) to have fastened seatbelts, the service state listener may listen for state changes in seatbelt states of the vehicle to detect that a seatbelt has been unfastened. In another example, if it is required that an item to be delivered remain in a designated location within the vehicle, the service state listener may listen for state changes in the location of the item (e.g., as indicated by image data showing a positional shift of the item within the vehicle, etc.). The changes in service state can trigger the vehicle state payload to be delivered to the application to instruct the user of actions that are needed to return the vehicle to an appropriate state to resume the service. For a delivery service, this can include a confirmation as to whether or not the item needs to be moved back into a certain position (e.g., upright, etc.). In some implementations, a vehicle with a human assistant can be deployed to an autonomous vehicle to re-position the item. If the vehicle has been placed into a service blocking state during a service, the user can be presented with a resume service element once the vehicle has been returned to an appropriate condition for a service. The user can interact with the resume service element to cause the vehicle to resume the service.

The vehicle service can end, at a sixth time 830. This can include, for example, the vehicle arriving at (or nearby) a drop-off location, the user exiting the vehicle, an item being removed from the vehicle, etc.

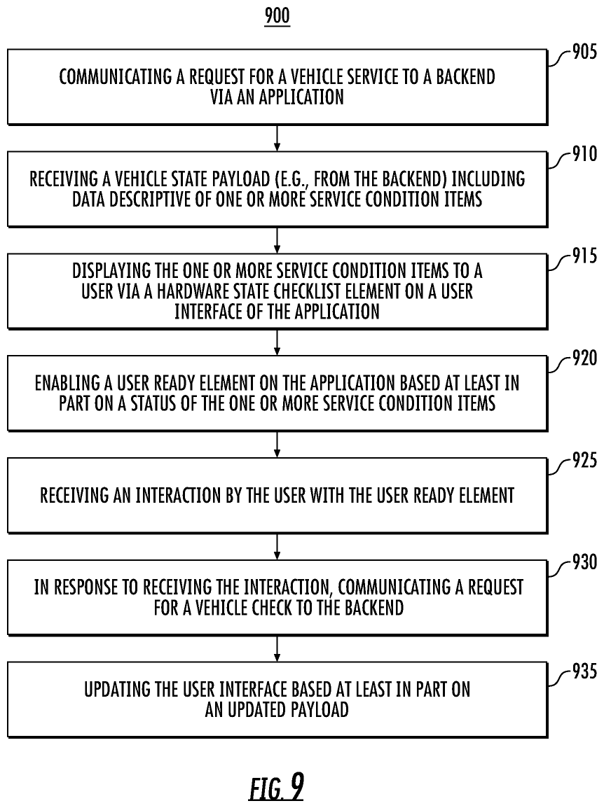

FIG. 9 depicts a flowchart diagram of an example method 900 for initiating a service and vehicle motion according to example embodiments of the present disclosure. One or more portion(s) of the method 900 can be implemented by one or more computing devices such as, for example, the computing devices described herein. In some implementations, one or more portions of the method 900 can be performed by a first device (e.g., a user device of the user, etc.) and one or more portions of the method 900 can be performed by a second device (e.g., a user device of the vehicle, etc.). Moreover, one or more portion(s) of the method can be implemented as an algorithm on the hardware components of the device(s) described herein. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At (905), the method 900 can include communicating a request for a vehicle service to a backend by an application. For instances, a computing system (e.g., a user device, client device, tablet onboard the vehicle, etc.) can communicate a request for a vehicle service to a backend via an application. The vehicle service can be a human user transportation (e.g., ride-sharing/ride-hailing service, etc.), a delivery service of one or more items, a courier service, etc. The vehicle for the vehicle service can be an autonomous vehicle. The backend can be a backend computing service of a transportation platform that coordinates vehicle services via autonomous vehicles.

At (910), the method 900 can include receiving a vehicle state payload (e.g., from the backend, etc.) including data descriptive of one or more service condition items. For instance, the computing system can receive a vehicle state payload from the backend. The vehicle state payload can include data descriptive of one or more service condition items. The one or more service condition items can be descriptive of one or more actions for placing an autonomous vehicle into appropriate condition for the vehicle service, as described herein.

In some implementations, prior to receiving the vehicle state payload from the backend, the computing system can provide, for display via a display device, a confirm service user interface to the user. The confirm service user interface can include a confirm service element. The computing system can receive data indicative of an interaction by the user with the confirm service element (e.g., a touch interaction with the user interface element, etc.). In response to receiving the data indicative of the interaction by the user with the confirm service element, the computing system can communicate a confirmation of the vehicle service to the backend.

In some implementations, the vehicle state payload can include at least one of a list of service blocking items, a task identifier, an action title, and/or an action description. In some implementations, the list of service blocking items includes at least one service blocking item data structure including a name, an icon reference, and a status.

At (915), the method 900 can include displaying the one or more service condition items to a user via a hardware state checklist element on a user interface of the application. For instance, the computing system (e.g., user device, etc.) can provide, for display via a user interface, the one or more service condition items to a user via a checklist element on the application. This can include displaying a service condition checklist user interface to the user. The service condition checklist user interface can include an action header element informing the user of urgent actions. The action header element can include directive text (e.g., instructing the user of a certain action, etc.), icons (e.g., graphics, etc.), and/or other information. The service condition checklist user interface can include a hardware state checklist element. The hardware state checklist element can include, for at least one service condition item of the one or more service condition items, an icon representing the at least one service condition item, a description of at least one service condition item, and/or a depiction of the status of the at least one service condition item. The status of the service condition item can include: an invalid status, a to-be-addressed status, an addressed status, or a warning status. In some implementations, the status can be associated with another state. In some implementations, the hardware state checklist can include at least one of: a doors closed condition, a trunk closed condition, a seatbelts fastened condition, or item secure condition.

The service condition checklist user interface can include a rules list element that includes, for at least one rule, an icon representing the at least one rule, a title of the at least one rule, and a description of the at least one rule. In some implementations, the service condition checklist user interface can include the user ready element (e.g., the user interface element, etc.).

At (920), the method 900 can include enabling a user ready element on the application based at least in part on a status of the one or more service condition items. For instance, the computing system can enable a user ready element on the application based at least in part on a status of the one or more service condition items indicating that the vehicle (e.g., autonomous vehicle, etc.) is in appropriate condition for the service. Enabling the user ready element can include, for example, making the user ready element appear on a user interface, changing it from a “grayed-out” status, making the user ready element selectable so that user input can be received via the user ready element, etc. In some implementations, the user is restricted from interacting with the user ready element until the status of the at least one service condition item includes the addressed status or the warning status.

At (925), the method 900 can include receiving an interaction by the user with the user ready element. For instance, the computing system can receive data indicative of an interaction by the user with the user ready element. The interaction can include, for example, a click interaction, touch interaction, voice interaction, etc.

At (930), the method 900 can include, in response to receiving the interaction, communicating a request for a vehicle check to the backend. For instance, in response to receiving the data indicative of the interaction, the computing system can communicate a request for a vehicle verification to the backend (e.g., of a cloud computing platform, etc.). The vehicle verification can include a review of an interior of the vehicle and/or the states of one or more of the vehicle's components.

At (935), the method 900 can include updating the user interface based at least in part on an updated payload. For instance, the computing system can receive an updated payload including a result of the vehicle verification (e.g., a cabin-check based on acquired sensor data descriptive of the vehicle health state, interior, component status, etc.). The computing system can provide, for display via the user interface, data indicative of the result of the vehicle verification to the user via at least a checklist element. This can include an indication of any service condition items to be addressed and/or that the vehicle service is ready.

The vehicle can initiate motion based at least in part on the completion of the service condition item(s) by the user and the vehicle verification by a remote computing system and/or remote operator. This can include an instruction being sent to the vehicle to begin travel in accordance with the vehicle service.

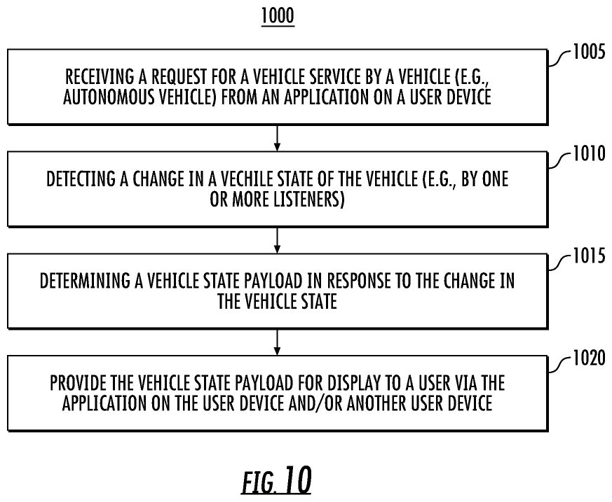

FIG. 10 depicts a flowchart diagram of another example method 1000 for initiating a service and vehicle motion according to example embodiments of the present disclosure. One or more portion(s) of the method 1000 can be implemented by one or more computing devices such as, for example, the computing devices described herein. In some implementations, one or more portions of the method 1000 can be performed by a first device (e.g., a user device of the user, etc.) and one or more portions of the method 1000 can be performed by a second device (e.g., a user device of the vehicle, etc.). Moreover, one or more portion(s) of the method can be implemented as an algorithm on the hardware components of the device(s) described herein. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At (1005), the method 1000 can include receiving a request for a vehicle service by a vehicle (e.g., autonomous vehicle) from an application on a user device. For instance, a computing system (e.g., server computing system, platform system, etc.) can receive a request for a vehicle service. The vehicle service can be one that is performed by a vehicle such as, for example, an autonomous vehicle. The request for the vehicle service can be provided via an application on a user device associated with a user and/or a user device of a vehicle, as described herein.

At (1010), the method 1000 can include detecting a change in a vehicle state of the vehicle (e.g., by one or more listeners). The computing system can determine a change in a vehicle state of the autonomous vehicle. The vehicle state can include, for example, at least one of a list of service blocking items, a task identifier, an action title, and/or an action description. In some implementations, the list of service blocking items can include at least one service blocking item data structure including a name, an icon reference, and a status. The change in the vehicle state can be determined by one or more listeners (e.g., an event listener that monitors and responds to the occurrence of an event, etc.). The listener(s) can include at least one of an itinerary report listener, a vehicle state listener, or a vehicle verification listener. For example, determining the change in the vehicle state of the autonomous vehicle can include detecting that an itinerary service has updated the vehicle state to a pickup status. In another example, determining the change in the vehicle state of the autonomous vehicle can include detecting that at least one of a door state, a trunk state, a seatbelt state, or an item secure state of the autonomous vehicle has changed by the one or more listeners. Each of the door state, the trunk state, the seatbelt state, and/or item secure state can include a unique listener of the one or more listeners. In some implementations, determining a change in the vehicle state of the vehicle by the one or more listeners can include determining that a vehicle verification has been completed (e.g., a verification of the vehicle's condition to perform the vehicle service).

At (1015), the method 1000 can include determining a vehicle state payload in response to the change in the vehicle state. For instance, the computing system can determine a vehicle state payload in response to the change in the vehicle state. The vehicle state payload can include data descriptive of one or more service condition items. The computing system can determine a vehicle state payload enabling a user ready element in response to determining that a status of the one or more service condition items is an addressed status.

At (1020), the method 1000 can include providing the vehicle state payload for display to a user via the application on the user device of the user and/or another user device (e.g., of the vehicle, etc.). For instance, the computing system can provide the vehicle state payload for display to a user via the application on the user device, as described herein.

The vehicle can initiate motion based at least in part on the completion of the service condition item(s) by the user and the vehicle verification by a remote computing system and/or remote operator. This can include an instruction being sent to the vehicle to begin travel in accordance with the vehicle service.

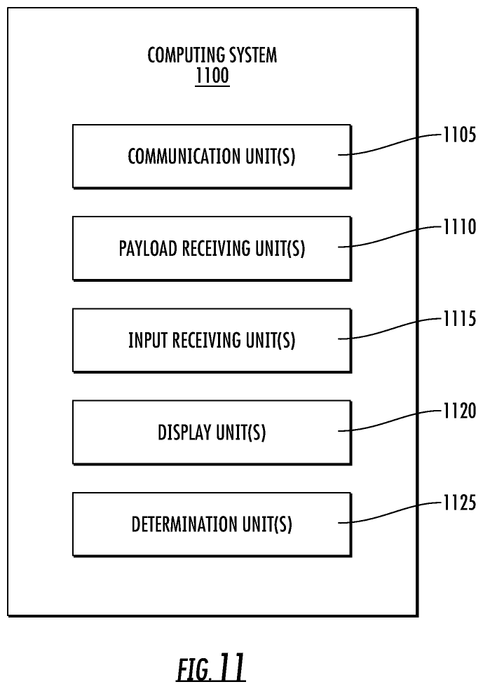

FIG. 11 depicts a block diagram of an example computing system 1100 according to example embodiments of the present disclosure. Various means can be configured to perform the methods and processes described herein. For example, a computing system 1100 can include communication unit(s) 1105, payload receiving unit(s) 1110, input receiving unit(s) 1115, display unit(s) 1120, determination unit(s) 1125, and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. The means can be programmed to perform one or more algorithm(s) for carrying out the operations and functions described herein.

For instance, the means (e.g., the communication unit(s) 1105, etc.) can be configured for communicating a request for a vehicle service to a backend via an application. The means (e.g., the payload receiving unit(s) 1110, etc.) can be configured for receiving a vehicle state payload from the backend. The vehicle state payload can include data descriptive of one or more service condition items. The one or more service condition items can be descriptive of one or more actions for placing an autonomous vehicle into appropriate condition for the vehicle service. The means (e.g., the display unit(s) 1120, etc.) can be configured for providing, for display via a user interface, the one or more service condition items to a user via a checklist element on the application. The means (e.g., the display unit(s) 1120, etc.) can be configured for enabling a user ready element on the application based at least in part on a status of the one or more service condition items indicating that the autonomous vehicle is in appropriate condition for the vehicle service. The means (e.g., the input receiving unit(s) 1115, etc.) can be configured for receiving data indicative of an interaction by the user with the user ready element. The means (e.g., the communication unit(s) 1105, etc.) can be configured for, in response to receiving the data indicative of the interaction, communicating a request for a vehicle verification to the backend.

In another example, the computing system 1100 can include various means for performing additional, or alternative, operations/functions. The means (e.g., the communication unit(s) 1105, etc.) can be configured for receiving a request for a vehicle service by an autonomous vehicle. The request for the vehicle service provided via an application on a user device. The means (e.g., the determining unit(s) 1125, etc.) can be configured for determining a change in a vehicle state of the autonomous vehicle. The means (e.g., the determining unit(s) 1125, etc.) can be configured for determining a vehicle state payload in response to the change in the vehicle state. The vehicle state payload can include, for example, data descriptive of one or more service condition items. The means (e.g., the communication unit(s) 1105, etc.) can be configured for providing the vehicle state payload for display to a user via the application on the user device.

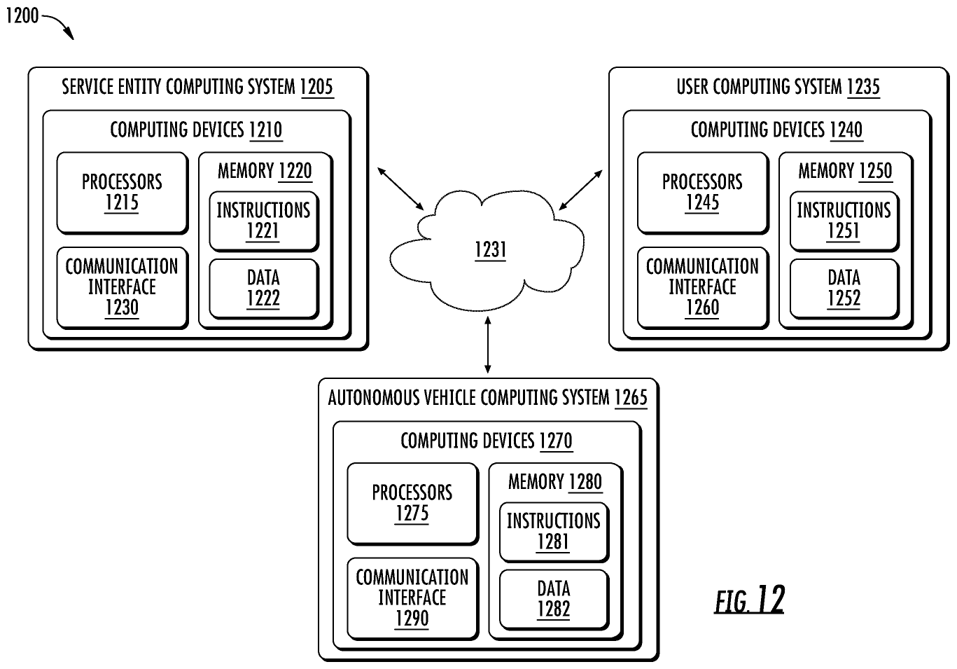

FIG. 12 depicts a block diagram of a computing ecosystem 1200 according to example embodiments of the present disclosure. The example ecosystem 1200 illustrated in FIG. 12 is provided as an example only. The components, systems, connections, and/or other aspects illustrated in FIG. 12 are optional and are provided as examples of what is possible, but not required, to implement the present disclosure. The example ecosystem 1200 can include a service entity computing system 1205 (e.g., that is associated with a service entity). The service entity computing system 1205 can represent/correspond to service entity computing system(s)/platform(s) described herein. The example ecosystem 1200 can include a user computing system 1235 (e.g., a computing device of a user, a user device of a vehicle kept within a vehicle interior, etc.). The user computing system 1235 can represent/correspond to a user device described herein. The example system 1200 can include an autonomous vehicle computing system 1265 (e.g., that is onboard an autonomous vehicle). The vehicle computing system 1265 (e.g., an autonomous vehicle computing system, etc.) can represent/correspond to a vehicle computing system, as described herein. The service entity computing system 1205, the user computing system 1235, and the vehicle computing system 1265 can be communicatively coupled to one another over one or more communication network(s) 1231. The networks 1231 can correspond to any networks described herein.

The computing device(s) 1210 of the service entity computing system 1205 can include processor(s) 1215 and a memory 1220. The one or more processors 1215 can be any suitable processing device (e.g., a processor core, a microprocessor, an ASIC, a FPGA, a controller, a microcontroller, etc.) and can be one processor or a plurality of processors that are operatively connected. The memory 1220 can include one or more non-transitory computer-readable storage media, such as RAM, ROM, EEPROM, EPROM, one or more memory devices, flash memory devices, data registrar, etc., and combinations thereof

The memory 1220 can store information that can be accessed by the one or more processors 1215. For example, the memory 1220 (e.g., one or more non-transitory computer-readable storage mediums, memory devices) can include computer-readable instructions 1221 that can be executed by the one or more processors 1215. The instructions 1221 can be software written in any suitable programming language or can be implemented in hardware. Additionally, or alternatively, the instructions 1221 can be executed in logically and/or virtually separate threads on processor(s) 1215.

For example, the memory 1220 can store instructions 1221 that when executed by the one or more processors 1215 cause the one or more processors 1215 (the service entity computing system 1205) to perform operations such as any of the operations and functions of the computing systems described herein, including one or more portions of the methods described herein. For example, the operations can include receiving a request for a vehicle service by an autonomous vehicle; determining a change in a vehicle state of the autonomous vehicle; determining a vehicle state payload in response to the change in the vehicle state, wherein the vehicle state payload includes data descriptive of one or more service condition items; and providing the vehicle state payload for display to a user of the autonomous vehicle via a user interface of a user device, wherein one or more service condition items are to be addressed by the user prior to allowing for initiation of the vehicle service by the autonomous vehicle.

The memory 1220 can store data 1222 that can be obtained (e.g., acquired, received, retrieved, accessed, created, stored, etc.). The data 1222 can include, for example, any of the data/information, described herein. In some implementations, the computing device(s) 1210 can obtain data from one or more memories that are remote from the service entity computing system 1205.

The computing device(s) 1210 can also include a communication interface 1230 used to communicate with one or more other system(s) remote from the service entity computing system, such as the user computing system 1235 and the vehicle computing system 1265. The communication interface 1230 can include any circuits, components, software, etc. for communicating via one or more networks (e.g., network(s) 1231). The communication interface 1230 can include, for example, one or more of a communications controller, receiver, transceiver, transmitter, port, conductors, software and/or hardware for communicating data.

The user computing system 1235 can include one or more computing device(s) 1240 that are remote from the service entity computing system 1205 and/or the vehicle computing system 1265. The computing device(s) 1240 can include one or more processors 1245 and a memory 1250. The one or more processors 1245 can be any suitable processing device (e.g., a processor core, a microprocessor, an ASIC, a FPGA, a controller, a microcontroller, etc.) and can be one processor or a plurality of processors that are operatively connected. The memory 1250 can include one or more tangible, non-transitory computer-readable storage media, such as RAM, ROM, EEPROM, EPROM, one or more memory devices, flash memory devices, data registrar, etc., and combinations thereof

The memory 1250 can store information that can be accessed by the one or more processors 1245. For example, the memory 1250 (e.g., one or more tangible, non-transitory computer-readable storage media, one or more memory devices, etc.) can include computer-readable instructions 1251 that can be executed by the one or more processors 1245. The instructions 1251 can be software written in any suitable programming language or can be implemented in hardware. Additionally, or alternatively, the instructions 1251 can be executed in logically and/or virtually separate threads on processor(s) 1245.

For example, the memory 1250 can store instructions 1251 that when executed by the one or more processors 1245 cause the one or more processors 1245 to perform operations such as any of the operations and functions described herein, including one or more portions of the methods described herein. For example, the operations can include any of the operations/functions of a user device described herein. The memory 1250 can store data 1252 that can be obtained. The data 1252 can include, for example, any of the data/information described herein.

The computing device(s) 1240 can also include a communication interface 1260 used to communicate with another computing device that is remote from the user computing system 1235, such as the vehicle computing system 1265 and service entity computing system 1205. The communication interface 1260 can include any circuits, components, software, etc. for communicating via one or more networks (e.g., network(s) 1231). The communication interface 1260 can include, for example, one or more of a communications controller, receiver, transceiver, transmitter, port, conductors, software and/or hardware for communicating data.

The vehicle computing system 1265 can include one or more computing device(s) 1270 that are remote from the service entity computing system 1205 and the user computing system 1235. The computing device(s) 1270 can include one or more processors 1275 and a memory 1280. The one or more processors 1275 can be any suitable processing device (e.g., a processor core, a microprocessor, an ASIC, a FPGA, a controller, a microcontroller, etc.) and can be one processor or a plurality of processors that are operatively connected. The memory 1280 can include one or more tangible, non-transitory computer-readable storage media, such as RAM, ROM, EEPROM, EPROM, one or more memory devices, flash memory devices, data registrar, etc., and combinations thereof

The memory 1280 can store information that can be accessed by the one or more processors 1275. For example, the memory 1280 (e.g., one or more tangible, non-transitory computer-readable storage media, one or more memory devices, etc.) can include computer-readable instructions 1281 that can be executed by the one or more processors 1275. The instructions 1281 can be software written in any suitable programming language or can be implemented in hardware. Additionally, or alternatively, the instructions 1281 can be executed in logically and/or virtually separate threads on processor(s) 1275.

For example, the memory 1280 can store instructions 1281 that when executed by the one or more processors 1275 cause the one or more processors 1275 to perform operations such as any of the operations and functions vehicle, one or more portions of the methods described herein, and/or one or more of the other operations and functions of the computing systems described herein. The memory 1280 can store data 1282 that can be obtained. The data 782 can include, for example, any of the data/information described herein.

The computing device(s) 1270 can also include a communication interface 1290 used to communicate with one or more system(s) onboard a vehicle and/or another computing device that is remote from the system 1265, such as user computing system 1235 and/or the service entity computing system 1205. The communication interface 1290 can include any circuits, components, software, etc. for communicating via one or more networks (e.g., network(s) 1231). The communication interface 1290 can include, for example, one or more of a communications controller, receiver, transceiver, transmitter, port, conductors, software and/or hardware for communicating data.

The network(s) 1231 can be any type of network or combination of networks that allows for communication between devices. In some implementations, the network(s) 1231 can include one or more of a local area network, wide area network, the Internet, secure network, cellular network, mesh network, peer-to-peer communication link and/or some combination thereof and can include any number of wired or wireless links. Communication over the network(s) 1231 can be accomplished, for example, via a communication interface using any type of protocol, protection scheme, encoding, format, packaging, etc.

Computing tasks discussed herein as being performed at computing device(s) remote from the vehicle can instead be performed at the vehicle (e.g., via the vehicle computing system), or vice versa. In some implementations, operations and functions described as being performed by one user device can be perform across a plurality of user devices (e.g., of the user, of the vehicle, etc.). Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method, comprising:
communicating, by a computing system comprising one or more computing devices, a request for a vehicle service to a backend via an application;
receiving, by the computing system, a vehicle state payload from the backend, the vehicle state payload comprising data descriptive of one or more service condition items, the one or more service condition items being descriptive of one or more actions for placing an autonomous vehicle into appropriate condition for the vehicle service;
providing, by the computing system for display via a user interface, the one or more service condition items to a user via a checklist element on the application;
enabling, by the computing system, a user ready element on the application based at least in part on a status of the one or more service condition items indicating that the autonomous vehicle is in appropriate condition for the vehicle service;
receiving, by the computing system, data indicative of an interaction by the user with the user ready element; and
in response to receiving the data indicative of the interaction, communicating, by the computing system, a request for a vehicle verification to the backend.

2. The computer-implemented method of claim 1, further comprising, prior to receiving the vehicle state payload from the backend:
providing, by the computing system for display via the user interface, a confirm service user interface to the user, the confirm service user interface comprising a confirm service element;
receiving, by the computing system, data indicative of an interaction by the user with the confirm service element; and
in response to receiving the data indicative of the interaction by the user with the confirm service element, communicating, by the computing system, a confirmation of the vehicle service to the backend.

3. The computer-implemented method of claim 1, wherein the vehicle verification comprises a review of an interior of the autonomous vehicle.

4. The computer-implemented method of claim 1, wherein providing, by the computing system for display via the user interface, the one or more service condition items to the user via the checklist element on the application further comprises displaying a service condition checklist user interface to the user, wherein the service condition checklist user interface comprises:
an action header element informing the user of one or more actions, the action header element comprising directive text;
a hardware state checklist element, wherein the hardware state checklist element comprises, for at least one service condition item of the one or more service condition items, an icon representing the at least one service condition item, a description of at least one service condition item, and a depiction of the status of the at least one service condition item;
a rules list element comprising, for at least one rule, an icon representing the at least one rule, a title of the at least one rule, and a description of the at least one rule; and
the user ready element.

5. The computer-implemented method of claim 4, wherein the status of the at least one service condition item comprises one of an invalid status, a to-be-addressed status, an addressed status, or a warning status.

6. The computer-implemented method of claim 5, wherein the user is restricted from interacting with the user ready element until the status of the at least one service condition item comprises the addressed status or the warning status.

7. The computer-implemented method of claim 4, wherein the hardware state checklist comprises at least one of a doors closed condition, a trunk closed condition, or a seatbelts fastened condition.

8. The computer-implemented method of claim 1, wherein the vehicle state payload comprises a list of service blocking items, a task identifier, an action title, and an action description.

9. The computer-implemented method of claim 8, wherein the list of service blocking items comprises at least one service blocking item data structure comprising a name, an icon reference, and a status.

10. The computer-implemented method of claim 1, further comprising:
receiving, by the computing system, an updated payload comprising a result of the vehicle verification; and
providing, by the computing system for display via the user interface, data indicative of the result of the vehicle verification to the user via at least the checklist element.

11. A computer-implemented method, comprising:
receiving, by a computing system comprising one or more computing devices, a request for a vehicle service by an autonomous vehicle, the request for the vehicle service provided via an application on a user device;
determining, by the computing system, a change in a vehicle state of the autonomous vehicle;
determining, by the computing system, a vehicle state payload in response to the change in the vehicle state, wherein the vehicle state payload comprises data descriptive of one or more service condition items; and
providing, by the computing system, the vehicle state payload for display to a user via the application on the user device.

12. The computer-implemented method of claim 11, wherein the vehicle state payload comprises a list of service blocking items, a task identifier, an action title, and an action description.

13. The computer-implemented method of claim 12, wherein the list of service blocking items comprises at least one service blocking item data structure comprising a name, an icon reference, and a status.

14. The computer-implemented method of claim 11, wherein the change in the vehicle state is determined by one or more listeners comprising at least one of an itinerary report listener, a vehicle state listener, or a vehicle verification listener.

15. The computer-implemented method of claim 11, wherein determining the change in the vehicle state of the autonomous vehicle comprises detecting that an itinerary service has updated the vehicle state to a pickup status.

16. The computer-implemented method of claim 14, wherein determining the change in the vehicle state of the autonomous vehicle comprises detecting that at least one of a door state, a trunk state, or a seatbelt state of the autonomous vehicle has changed by the one or more listeners.

17. The computer-implemented method of claim 16, wherein each of the door state, the trunk state, and the seatbelt state comprises a unique listener of the one or more listeners.

18. The computer-implemented method of claim 14, wherein determining a change in the vehicle state of the vehicle by the one or more listeners comprises determining that a vehicle verification has been completed.

19. The computer-implemented method of claim 11, wherein determining, by the computing system, the vehicle state payload further comprises determining, by the computing system, a vehicle state payload enabling a user ready element in response to determining, by the computing system, that a status of the one or more service condition items is an addressed status.

20. A computing system, comprising:
one or more processors;
one or more non-transitory computer-readable media that store instructions that, when executed by the one or more processors, cause the computing system to perform operations, the operations comprising:
receiving a request for a vehicle service by an autonomous vehicle;
determining a change in a vehicle state of the autonomous vehicle;
determining a vehicle state payload in response to the change in the vehicle state, wherein the vehicle state payload comprises data descriptive of one or more service condition items; and
providing the vehicle state payload for display to a user of the autonomous vehicle via a user interface of a user device, wherein one or more service condition items are to be addressed by the user prior to allowing for initiation of the vehicle service by the autonomous vehicle.
